(19) United States
(12) Patent Application Publication
(10) Pub. No.: US 2006/0132867 A1
(43) Pub. Date: Jun. 22, 2006

(54) Tone reproduction characteristics measuring device for color monitor

(76) Inventors: Tohru Sugiyama, Tokyo (JP); Tsutomu Nakagawa, Tokyo (JP)

Correspondence Address: LADAS & PARRY, 26 WEST 61ST STREET, NEW YORK, NY, 10023, US

(21) Appl. No.: 10/559,853

(22) PCT Filed: Jun. 11, 2004
(86) PCT No.: PCT/JP04/08586

§ 371 Date: Dec. 7, 2005

(30) Foreign Application Priority Data
Jun. 16, 2003 (JP) 2003-170623
Jan. 23, 2004 (JP) 2004-15182

(51) Int. Cl. H04N 1/46

(52) U.S. Cl. 358/504

(57) ABSTRACT

The tone reproduction characteristics of a color monitor are determined at high precision by visual recognition. A pattern display means (230) displays a test pattern, comprising circular patterns (50) and a background (60), on the screen of the monitor (100) to be measured. In the background (60), a reference pattern, which is generated by a reference pattern generating means (220), is formed of a black-and-white pattern, and has a prescribed reference luminance, is displayed, and in each circular pattern (50), an even pattern with RGB tone values designated by a tone value designating means (210) is displayed. The tone of the even pattern is varied so as to vary in brightness and color by a tone value varying means (240). When the circular patterns (50) become the same in brightness and color as the background (60), an operator provides a coincidence signal to a coincidence signal input means (250). A characteristics computing means (260) computes curves, indicating the tone reproduction characteristics according to the respective colors of R, G, and B, based on the reference luminance and the corresponding tone values at this point. The circular patterns (50) are positioned at a pitch that is in accordance with the spatial frequency sensitivity of human eyes.

### TECHNICAL FIELD

This invention relates to a tone reproduction characteristics measuring device for color monitor, and particularly relates to a device for determining, by visual recognition, tone reproduction characteristics, which indicate the relationship between input signal tone values and actual display luminance, of a color monitor having a function of displaying color images using the three primary colors, R, G, and B.

### BACKGROUND ART

Generally, the display characteristics of monitors (display devices) differ according to each individual product, and in the case of use upon connection to a personal computer, etc., corrections are preferably carried out in accordance with the individual display characteristics. To carry out such corrections, the display characteristics of each individual monitor must be measured and the results must be prepared as objective data in advance. Normally, such data are referred to as the profile data of each individual monitor. In connecting a monitor to a personal computer, by incorporating the profile data of the monitor in the personal computer, corrections based on the profile data are enabled and universal display results that are not affected by the display characteristics unique to the individual monitor can be obtained.

The representative display characteristics of a color monitor having a function of displaying color images using the three primary colors, R, G, and B, are the chromaticities of the three primary colors, the chromaticity of white, and the tone reproduction characteristics. Here, the tone reproduction characteristics indicate the relationship between input signal tone values and actual display luminance and is normally called the gamma characteristics. If corrections that are in accordance with the tone reproduction characteristics are not carried out, individual monitors will perform image displays that differ in luminous distribution even if the displayed image is based on exactly the same image data. The performing of corrections in accordance with the unique tone reproduction characteristics of each individual monitor (so-called gamma correction) is thus extremely important for practical use. A general method for such gamma correction is disclosed for example in Japanese Unexamined Patent Publication No. 162714/1995.

Though among methods of measuring the tone reproduction characteristics of each individual monitor, there are methods wherein physical characteristics data are obtained using an optical measuring device, a method of obtaining characteristics data while carrying out visual recognition by human eyes is normally employed. This is because a monitor is actually used by humans and characteristics data obtained by a measurement method based on luminance perceived sensually by human vision are preferable over characteristics data obtained by a purely physical measurement method. A method of obtaining tone reproduction characteristics by visual recognition is, for example, disclosed in Japanese Patent Publication No. 2889078.

Though as mentioned above, the obtaining of tone reproduction characteristics by visual recognition for each individual monitor is extremely important in terms of performing corrections that match the sensitivity characteristics of human eyes, tone reproduction characteristics cannot be determined at adequate precision with conventionally proposed measuring methods and measuring devices using visual recognition. In particular, in the case of a color monitor used in DTP processes for preparing printed matter, tone reproduction characteristics must be determined at higher precision in order to perform corrections of high precision. However, with conventional arts, measurements of adequate precision cannot be carried out on liquid crystal color displays or CRT color monitors that have undergone aged deterioration.

An object of this invention is thus to provide a tone reproduction characteristics measuring device for color monitor that enables the tone reproduction characteristics to be determined at high precision by visual recognition.

### DISCLOSURE OF INVENTION

(1) The first feature of the present invention resides in a device for measuring tone reproduction characteristics, which indicate a relationship between input signal tone values and actual display luminance of a color monitor having a function of displaying color images using three primary colors of R, G, and B, the tone reproduction characteristics measuring device for color monitor comprising:

tone value designating means, designating a combination of tone values of the three primary colors, R, G, and B, for displaying an even pattern of uniform brightness and color in a first attribute region;

reference pattern generating means generating a reference pattern in which first sub-regions and second sub-regions are mixed at a prescribed area ratio inside a second attribute region, wherein each of the three primary colors, R, G, and B take on a minimum tone value in the first sub-regions and each of the three primary colors, R, G, and B take on a maximum tone value in the second sub-regions;

pattern display means defining a test pattern which is arranged from the first attribute region and the second attribute region being positioned so as to contact each other on a screen of the color monitor, and providing prescribed signals to the color monitor so that an even pattern, based on the combination of tone values designated by the tone value designating means, is displayed in the first attribute region, and the reference pattern, generated by the reference pattern generating means, is displayed in the second attribute region;

tone value varying means varying respective tone values designated by the tone value designating means so as to vary a brightness and a color of the even pattern;

coincidence signal input means inputting, while a varying operation by the tone value varying means is being performed, a coincidence signal indicating a recognition that the first attribute region and the second attribute region are matched in both brightness and color, from an operator who views the test pattern displayed on the screen of the color monitor; and

characteristics computing means recognizing a combination of tone values designated by the tone value designating means at a point when the coincidence signal is input, as corresponding tone values of the respective primary colors that correspond to a prescribed reference luminance in accordance with the prescribed area ratio, and determining, by computation, tone reproduction characteristics of the respective primary colors based on the reference luminance and the corresponding tone values that correspond to each other.

(2) The second feature of the present invention resides in the tone reproduction characteristics measuring device for color monitor according to the first feature, wherein:

the tone value varying means has a function of performing two types of varying operations of a brightness varying operation, with which the tone values are varied so that mainly a brightness of the even pattern changes, and a color varying operation, with which a tone value is varied so that mainly a color of the even pattern changes.

(3) The third feature of the present invention resides in the tone reproduction characteristics measuring device for color monitor according to the second feature, wherein:

the brightness varying operation is performed by a task of increasing or decreasing all of respective tone values of the three primary colors, R, G, and B by a common variation amount, and

the color varying operation is performed by a task of increasing or decreasing a tone value of a single specific color among the three primary colors, R, G, and B.

(4) The fourth feature of the present invention resides in the tone reproduction characteristics measuring device for color monitor according to the first to third features, wherein:

the tone value varying means performs variations of the tone values based on operation inputs by the operator.

(5) The fifth feature of the present invention resides in the tone reproduction characteristics measuring device for color monitor according to the fourth feature, wherein:

the tone value varying means uses a first button that provides an instruction of making the even pattern brighter, a second button that provides an instruction of making the even pattern darker, a third button that provides an instruction of strengthening a component of a specific color of the even pattern, and a fourth button that provides an instruction of weakening a component of the specific color of the even pattern, and performs a varying operation of adding a common variation amount to all of the respective tone values of the three primary colors, R, G, and B, when there is an operation input in regard to the first button, performs a varying operation of subtracting a common variation amount from all of the respective tone values of the three primary colors, R, G, and B, when there is an operation input in regard to the second button, performs a varying operation of adding a prescribed variation amount to a tone value of the specific color when there is an operation input in regard to the third button, and performs a varying operation of subtracting a prescribed variation amount from a tone value of the specific color when there is an operation input in regard to the fourth button.

(6) The sixth feature of the present invention resides in the tone reproduction characteristics measuring device for color monitor according to the fifth feature, wherein:

a two-dimensional XY coordinate system is defined and the respective buttons are positioned so that the first button and the second button are positioned at opposing positions along an X-axis that sandwich an origin and the third button and the fourth button are positioned at opposing position along a Y-axis that sandwich the origin.

(7) The seventh feature of the present invention resides in the tone reproduction characteristics measuring device for color monitor according to the first to third features, wherein:

the tone value varying means varies the tone values with time in accordance with prescribed rules that have been established in advance.

(8) The eighth feature of the present invention resides in the tone reproduction characteristics measuring device for color monitor according to the seventh feature, wherein:

the tone value varying means has a function of performing two varying operations of a brightness varying operation, wherein, by adding or subtracting a common variation amount at a prescribed timing to or from all of respective tone values of the three primary colors, R, G, and B, the tone values are varied so that mainly the brightness of the even pattern changes, and a color varying operation, wherein, by adding or subtracting a prescribed variation amount at a prescribed timing to or from a tone value of one specific color among the three primary colors, R, G, and B, the tone value is varied so that mainly the color of the even pattern changes, and
the coincidence signal input means has a brightness coincidence signal input means, for inputting, while the tone value varying means is performing the brightness varying operation, a brightness coincidence signal that indicates a recognition that the brightness is matched from the operator, and a color coincidence signal input means, for inputting, while the tone value varying means is performing the color varying operation, a color coincidence signal that indicates a recognition that the color is matched from the operator, and deems that a coincidence signal indicating a recognition of matching of both brightness and color is input when both inputs of the brightness coincidence signal and the color coincidence signal are completed.

(9) The ninth feature of the present invention resides in the tone reproduction characteristics measuring device for color monitor according to the eighth feature, wherein:

when a tone value obtained by a varying operation of adding a variation amount exceeds a maximum tone value, a circulation process of incrementing a minimum tone value by an excess amount is performed, and when a tone value obtained by a varying operation of subtracting a variation amount falls below the minimum tone value, a circulation process of decrementing a maximum tone value by an excess amount is performed.

(10) The tenth feature of the present invention resides in the tone reproduction characteristics measuring device for color monitor according to the eighth or ninth feature, wherein:

the tone value varying means has a function of starting the color varying operation at a point when the brightness coincidence signal is input while the brightness varying operation is performed, starting the brightness varying operation at a point when the color coincidence signal is input while the color varying operation is performed, and repeatedly executing the brightness varying operation and the color varying operation in alternation and has a function of performing a repeated execution while gradually decreasing the tone value variation amount, and

the coincidence signal input means deems that the coincidence signal indicating a recognition of matching of both brightness and color is input when both inputs of the brightness coincidence signal and the color coincidence signal are completed after the variation amount has reached a predefined value.

(11) The eleventh feature of the present invention resides in the tone reproduction characteristics measuring device for color monitor according to the third, fifth or eighth feature, wherein:

of the three primary colors, R, G, and B, the primary color B is deemed to be the specific color and tone reproduction characteristics for the primary color B and tone reproduction characteristics in common to the primary colors R and G are determined.

(12) The twelfth feature of the present invention resides in the tone reproduction characteristics measuring device for color monitor according to the first to eleventh features, wherein:

the reference pattern generating means has a function of setting a plurality N of area ratios of the first sub-regions to the second sub-regions and generating N reference patterns that differ mutually in reference luminance, and

the characteristics computing means has a function of determining the tone reproduction characteristics for the respective primary colors based on N corresponding tone values obtained for N test patterns using the N reference patterns.

(13) The thirteenth feature of the present invention resides in the tone reproduction characteristics measuring device for color monitor according to the twelfth feature, wherein:

the characteristics computing means defines a two-dimensional coordinate system in which a first coordinate axis is set for tone value and a second coordinate axis is set for luminance, plots N points having respective luminance values and corresponding tone values as coordinate values on the coordinate system, plots a point having a minimum luminance value and a minimum tone value as coordinate values, and a point having a maximum luminance value and a maximum tone value as coordinate values, and determines a curve passing through the total of (N+2) plotted points in a form of a graph that indicates the tone reproduction characteristics.

(14) The fourteenth feature of the present invention resides in the tone reproduction characteristics measuring device for color monitor according to the thirteenth feature, wherein:

N is set equal to 3, a total of five points are plotted, and upon referring to these five points as a first point to a fifth point in the order of increasing coordinate value along the first coordinate axis, a first function curve, passing through the first, second, and third points and taking a form of expressing the luminance as a power of the tone value, and a second function curve, passing through the third, fourth, and fifth points and taking a form of expressing the luminance as a power of the tone value are determined by computation, and a curve formed by joining the first function curve and the second function curve is deemed to be the curve expressing the tone reproduction characteristics.

(15) The fifteenth feature of the present invention resides in the tone reproduction characteristics measuring device for color monitor according to the first to fourteenth features, wherein:

the reference pattern generating means forms the first sub-regions and the second sub-regions from unit cells having the same shape and size and forms the reference pattern from a two-dimensional array of these unit cells.

(16) The sixteenth feature of the present invention resides in the tone reproduction characteristics measuring device for color monitor according to the fifteenth feature, wherein:

the reference pattern is formed by arraying rectangular unit cells in a two-dimensional array, and for arbitrary odd numbers i and j, a cell group, formed of four unit cells of a unit cell of an i-th row and a j-th column, a unit cell of the i-th row and a (j+1)-th column, a unit cell of an (i+1)-th row and the j-th column, and a unit cell of the (i+1)-th row and the (j+1)-th column, is defined, and a common positioning pattern of the first sub-regions and the second sub-regions is applied for all cell groups.

(17) The seventeenth feature of the present invention resides in the tone reproduction characteristics measuring device for color monitor according to the sixteenth feature, wherein:

among the four unit cells which make up a cell group, first sub-regions are formed by a pair of unit cells adjacent diagonally and second sub-regions are formed by a remaining pair of unit cells so as to constitute a reference pattern with an area ratio of 1:1.

(18) The eighteenth feature of the present invention resides in the tone reproduction characteristics measuring device for color monitor according to the sixteenth feature, wherein:

among the four unit cells which make up a cell group, one unit cell constitutes one sub-region and remaining three unit cells constitute the other sub-region so as to constitute a reference pattern with an area ratio of 3:1 or 1:3.

(19) The nineteenth feature of the present invention resides in the tone reproduction characteristics measuring device for color monitor according to the first to eighteenth features, wherein:

a contour of the first attribute region or the second attribute region that makes up the test pattern is made of a circle or an ellipse.

(20) The twentieth feature of the present invention resides in the tone reproduction characteristics measuring device for color monitor according to the first to nineteenth features, wherein:

one attribute region that makes up the test pattern is made of a plurality of regions positioned in a dispersed manner and the other attribute region is made of a background portion thereof.

(21) The twenty-first feature of the present invention resides in the tone reproduction characteristics measuring device for color monitor according to the twentieth feature, wherein:

a total area of the first attribute region is made equal to a total area of the second attribute region.

(22) The twenty-second feature of the present invention resides in the tone reproduction characteristics measuring device for color monitor according to the twentieth or twenty-first feature, wherein:

a plurality of regions of the same attribute that are the same in shape and size are positioned dispersedly in a two-dimensional plane at a prescribed pitch so that a prescribed spatial frequency is obtained.

(23) The twenty-third feature of the present invention resides in the tone reproduction characteristics measuring device for color monitor according to the twenty-second feature, wherein:

a plurality of one-dimensional region arrays, in each of which a plurality of regions of the same attribute are positioned in a horizontal direction at a prescribed pitch Px, are positioned in a vertical direction at a prescribed pitch Py (where Py=(√3)/2·Px) and positioned so that among mutually adjacent one-dimensional region arrays, the phase is shifted by half a pitch.

(24) The twenty-fourth feature of the present invention resides in the tone reproduction characteristics measuring device for color monitor according to the twenty-second or twenty-third feature, wherein:

regions of the same attribute are positioned dispersedly at a prescribed pitch by which a spatial frequency that exhibits good sensitivity in regard to both brightness difference discrimination characteristics and color difference discrimination characteristics for the operator viewing the test pattern is obtained.

(25) The twenty-fifth feature of the present invention resides in the tone reproduction characteristics measuring device for color monitor according to the twenty-second or twenty-third feature, wherein:

a first pitch, by which a spatial frequency that exhibits good sensitivity in regard to brightness difference discrimination characteristics for the operator viewing the test pattern is obtained, and a second pitch, by which a spatial frequency that exhibits good sensitivity in regard to color difference discrimination characteristics for the operator viewing the test pattern is obtained, are set, and

the pattern display means has a function of displaying a test pattern, formed by dispersedly positioning regions of the same attribute at the first pitch, when a brightness matching recognition task is performed by the operator, and displaying a test pattern, formed by dispersedly positioning regions of the same attribute at the second pitch, when a color matching recognition task is performed by the operator.

(26) The twenty-sixth feature of the present invention resides in a program for making a computer function as the measuring device according to the first to twenty-fifth features, or a computer-readable recording medium in which the program is recorded.

(27) The twenty-seventh feature of the present invention resides in a device for measuring tone reproduction characteristics, which indicate a relationship between input signal tone values and actual display luminance of a color monitor having a function of displaying color images using three primary colors of R, G, and B, the tone reproduction characteristics measuring device for color monitor comprising:

tone reproduction characteristics storage means storing provisional tone reproduction characteristics;

image data storage means storing image data of a sample image to be used in measurement;

image display means which assumes that the tone reproduction characteristics of the color monitor are to be the provisional tone reproduction characteristics stored in the tone reproduction characteristics storage means, performs prescribed tone corrections on image data stored in the image data storage means so that the sample image will be displayed with correct tone reproduction on the color monitor, and provides corrected image data to the color monitor;

a physical output medium obtained by outputting the sample image on a physical medium based on the image data stored in the image data storage means;

characteristics modifying means receiving instruction inputs, for making a sample image displayed on a screen of the color monitor, and a sample image displayed on the physical output medium, close in brightness and color, from an operator who visually compares the two images;

coincidence signal input means inputting a coincidence signal, indicating a recognition that both of the images are matched both in brightness and color, from the operator; and

characteristics output means outputting the provisional tone reproduction characteristics, stored in the tone reproduction characteristics storage means when the coincidence signal is input, as a formal tone reproduction characteristics of the color monitor.

(28) The twenty-eighth feature of the present invention resides in the tone reproduction characteristics measuring device for color monitor according to the twenty-seventh feature, wherein:

image data of a plurality M of sample images that differ in overall brightness are stored in the image data storage means and M physical output media, respectively corresponding to the M sample images, are prepared; and

the characteristics modifying means, upon receiving an instruction input concerning an i-th sample image among the M sample images, performs modifications stressed on “a portion corresponding to a brightness of the i-th sample image” on the provisional tone reproduction characteristics stored in the tone reproduction characteristics storage means.

(29) The twenty-nineth feature of the present invention resides in the tone reproduction characteristics measuring device for color monitor according to the twenty-eighth feature, wherein:

the tone reproduction characteristics storage means stores curves, respectively indicating relationships between tone value and luminance for the three primary colors, R, G, and B, in a form of graphs indicating the tone reproduction characteristics, and

the characteristics modifying means, upon receiving an instruction input concerning an i-th sample image, recognizes a point on a curve, having a representative tone value of the i-th sample image, as a control point, and after moving the control point in a prescribed direction in accordance with the instruction input, modifies the curve smoothly so that it passes through the control point after movement.

(30) The thirtieth feature of the present invention resides in the tone reproduction characteristics measuring device for color monitor according to the twenty-ninth feature, wherein:

a mode value or an average value of pixel values of all colors of individual pixels indicated by the image data stored in the image data storage means is used as a representative tone value of the sample image.

(31) The thirty-first feature of the present invention resides in the tone reproduction characteristics measuring device for color monitor according to the twenty-eighth feature, wherein:

the tone reproduction characteristics storage means stores curves, respectively indicating relationships between tone value and luminance for the three primary colors, R, G, and B, in a form of graphs indicating the tone reproduction characteristics, and

the characteristics modifying means, upon receiving an instruction input concerning an i-th sample image, recognizes a point on a curve, having a representative luminance value of the i-th sample image, as a control point, and after moving the control point in a prescribed direction in accordance with the instruction input, modifies the curve smoothly so that it passes through the control point after movement.

(32) The thirty-second feature of the present invention resides in the tone reproduction characteristics measuring device for color monitor according to the thirty-first feature, wherein:

a mode value or an average value of pixel values of all colors of individual pixels indicated by the image data stored in the image data storage means is determined as the representative tone value of the sample image, and a value converted by a prescribed conversion method based on the determined representative tone value is used as the representative luminance value of the sample image.

(33) The thirty-third feature of the present invention resides in the tone reproduction characteristics measuring device for color monitor according to the thirty-first feature, wherein:

an actually measured value of luminance of an entire sample image on the physical output medium is used as the representative luminance value of the sample image.

(34) The thirty-fourth feature of the present invention resides in the tone reproduction characteristics measuring device for color monitor according to the twenty-seventh feature, wherein:

the characteristics modifying means performs processes of varying the tone reproduction characteristics with time in accordance with prescribed rules that have been established in advance and performs modifications wherein provisional tone reproduction characteristics when an instruction input from the operator is provided are deemed to be new provisional tone reproduction characteristics.

(35) The thirty-fifth feature of the present invention resides in the tone reproduction characteristics measuring device for color monitor according to the thirty-fourth feature, wherein:

image data of a plurality M of sample images that differ in overall brightness are stored in the image data storage means and M physical output media, respectively corresponding to the M sample images are prepared; and

the characteristics modifying means has a function of executing processes of performing variations stressed on “a portion corresponding to a brightness of an i-th sample image among the M sample images” on the provisional tone reproduction characteristics stored in the tone reproduction characteristics storage means for each of i=1 to M.

(36) The thirty-sixth feature of the present invention resides in the tone reproduction characteristics measuring device for color monitor according to the thirty-fifth feature, wherein:

the tone reproduction characteristics storage means stores curves, respectively indicating relationships between tone value and luminance for the three primary colors, R, G, and B, in a form of graphs indicating the tone reproduction characteristics, and

the characteristics modifying means, in executing a process of performing variations stressed on “a portion corresponding to a brightness of an i-th sample image,” recognizes a point on each of the curves, having a representative tone value of the i-th sample image, as a control point, moves the control point in prescribed directions cyclically, and modifies the curve smoothly so that it passes through the control point after movement.

(37) The thirty-seventh feature of the present invention resides in the tone reproduction characteristics measuring device for color monitor according to the thirty-sixth feature, wherein:

a mode value or an average value of pixel values of all colors of individual pixels indicated by the image data stored in the image data storage means is used as the representative tone value of the sample image.

(38) The thirty-eighth feature of the present invention resides in the tone reproduction characteristics measuring device for color monitor according to the thirty-fifth feature, wherein:

the tone reproduction characteristics storage means stores curves, respectively indicating relationships between tone value and luminance for the three primary colors, R, G, and B, in a form of graphs indicating the tone reproduction characteristics, and

the characteristics modifying means, in executing a process of performing variations stressed on “a portion corresponding to a brightness of an i-th sample image,” recognizes a point on each of the curves, having a representative luminance value of the i-th sample image, as a control point, moves the control point in prescribed directions cyclically, and modifies the curve smoothly so that it passes through the control point after movement.

(39) The thirty-ninth feature of the present invention resides in the tone reproduction characteristics measuring device for color monitor according to the thirty-eighth feature, wherein:

a mode value or an average value of pixel values of all colors of individual pixels indicated by the image data stored in the image data storage means is determined as the representative tone value of the sample image, and a value converted by a prescribed conversion method based on the determined representative tone value is used as the representative luminance value of the sample image.

(40) The fortieth feature of the present invention resides in the tone reproduction characteristics measuring device for color monitor according to the thirty-eighth feature, wherein:

an actually measured value of luminance of an entire sample image on the physical output medium is used as the representative luminance value of the sample image.

(41) The forty-first feature of the present invention resides in the tone reproduction characteristics measuring device for color monitor according to the twenty-seventh to fortieth features, wherein:

the characteristics modifying means has a function of performing two types of modifying operations of a brightness modifying operation of modifying the tone reproduction characteristics based on an instruction input for mainly changing the brightness of the sample image displayed on a screen of the color monitor, and a color modifying operation of modifying the tone reproduction characteristics based on an instruction input for mainly changing the color.

(42) The forty-second feature of the present invention resides in the tone reproduction characteristics measuring device for color monitor according to forty-first feature, wherein:

the tone reproduction characteristics storage means stores curves, respectively indicating relationships between tone value and luminance for the three primary colors, R, G, and B, in a form of graphs indicating the tone reproduction characteristics, and

the characteristics modifying means, performs modification on all of the respective curves of the three primary colors R, G, and B in performing the brightness modifying operation, and performs modification on only a curve of a color to be modified in performing the color modifying operation.

(43) The forty-third feature of the present invention resides in the tone reproduction characteristics measuring device for color monitor according to the twenty-seventh to forty-second features, wherein:

an image, which can be recognized as a substantially achromatic image when viewed by the operator, is used as the sample image.

(44) The forty-fourth feature of the present invention resides in a program for making a computer function as the tone reproduction characteristics storage means, image data storage means, image display means, characteristics varying means, coincidence signal input means, and characteristics output means in the measuring device according to the twenty-seventh to forty-third features or a computer-readable recording medium in which the program is recorded.

(45) The forty-fifth feature of the present invention resides in a device for measuring tone reproduction characteristics, which indicate a relationship between input signal tone values and actual display luminance of a color monitor having a function of displaying color images using three primary colors of R, G, and B, the tone reproduction characteristics measuring device for color monitor comprising:

means for determining a correspondence between luminance and tone value by visual recognition;

means for determining a combination of tone values of the three primary colors that appears to be achromatic; and

characteristics computing means determining, by computation, the tone reproduction characteristics for the respective primary colors from the correspondence between luminance and tone value and a combination of the three primary colors.

### BRIEF DESCRIPTION OF DRAWINGS

FIG. 1 is a block diagram showing a state wherein a personal computer 200, which is to function as a monitor characteristics measuring device, is connected to a monitor 100, which is to be measured.

FIG. 2 is a graph showing the general tone reproduction characteristics of a monitor.

FIGS. 3A and 3B are diagrams illustrating the basic principles of a representative method for measuring tone reproduction characteristics by visual recognition, with FIG. 3A being a plan view showing a test pattern to be displayed to an operator and FIG. 3B being a partially enlarged view of a second attribute region 20 inside the test pattern.

FIG. 4 is a graph showing the tone reproduction characteristics determined based on the measurement results using the test pattern shown in FIGS. 3A and 3B.

FIG. 5 is a graph showing the results of measuring tone reproduction characteristics for each of the primary colors for a general color monitor.

FIG. 6 is a plan view showing an example of an operation panel used for carrying out a brightness varying operation and a color varying operation based on operation inputs of an operator.

FIG. 7 is a plan view showing another example of an operation panel used for carrying out a brightness varying operation and a color varying operation based on operation inputs of an operator.

FIG. 8 is a plan view showing an example of an operation panel used for carrying out a brightness varying operation and a color varying operation automatically and making an operator perform a matching input operation.

FIG. 9 is a flowchart showing an example of a processing procedure of repeatedly executing an operation of matching the brightness and an operation of matching the color in alternation.

FIG. 10 is a graph for describing an embodiment for determining an approximate function curve that passes through the five points O, Q1, Q2, Q3, and P by computation.

FIG. 11 is a graph for describing the computation in a case where the approximate function curve that passes through the five points O, Q1, Q2, Q3, and P is a sigmoid curve.

FIG. 12A is plan view showing a new test pattern by which more preferable measurement results can be obtained, and FIG. 12B is an enlarged view of a reference pattern that is displayed inside second attribute region 60 of this test pattern.

FIG. 13A is a plan view showing an example wherein a reference pattern of a reference luminance of 25% is formed using a reference pattern, wherein rectangular unit cells are arrayed in a two-dimensional array, and FIG. 13B is a plan view showing an example wherein a reference pattern of a reference luminance of 75% is formed using a reference pattern, wherein rectangular unit cells are arrayed in a two-dimensional array.

FIG. 14 is a plan view of an example wherein regions 70 of the same attribute are formed by circles of the same radius r and positioned at a prescribed pitch on a two-dimensional plane.

FIG. 15 is a plan view for describing the sensitivity of a visual perception system wherein a pair of objects (circular regions of the same attribute) 70 are positioned at a pitch Px.

FIG. 16 is a graph showing the sensitivity characteristics of the human visual perception system, with the abscissa indicating the spatial frequency of an observed object (unit: cycle/deg) in logarithmic scale and the ordinate indicating the relative sensitivity value of the human visual perception system for distinguishing brightness differences and color differences of an object.

FIG. 17 is a table showing the respective optimal values extracted from the graph shown in FIG. 16.

FIG. 18 is a block diagram showing the basic arrangement of this invention's tone reproduction characteristics measuring device for color monitor.

FIG. 19 is a plan view showing sample images used in another tone reproduction characteristics measuring method for color monitor by this invention.

FIG. 20 is a graph showing the principles of tone reproduction characteristics modification in the tone reproduction characteristics measuring method using the sample images shown in FIG. 19.

FIG. 21 is a plan view showing an example of a screen for modification operation by an operator using sample image Ha shown in FIG. 19.

FIG. 22 is a plan view showing an example of a screen for modification operation by an operator using sample image Hb shown in FIG. 19.

FIG. 23 is a plan view showing an example of a screen for modification operation by an operator using sample image Hc shown in FIG. 19.

FIG. 24 is a block diagram showing the basic arrangement of a reproduction characteristics measuring device for color monitor that uses a sample image by this invention.

FIG. 25 is a flowchart illustrating the characteristics measurement process procedures using the measuring device shown in FIG. 24.

FIG. 26 is a diagram showing the representative tone values and the representative luminance values determined for the respective sample images shown in FIG. 19.

FIG. 27 is a graph showing the principles of tone reproduction characteristics modification in the tone reproduction characteristics measuring method using the sample images shown in FIG. 26.

### BEST MODE FOR CARRYING OUT THE INVENTION

This invention will now be described based on the illustrated embodiments.

<<<Section 1. General Conventional Method for Measuring Tone Reproduction Characteristics by Visual Recognition>>>

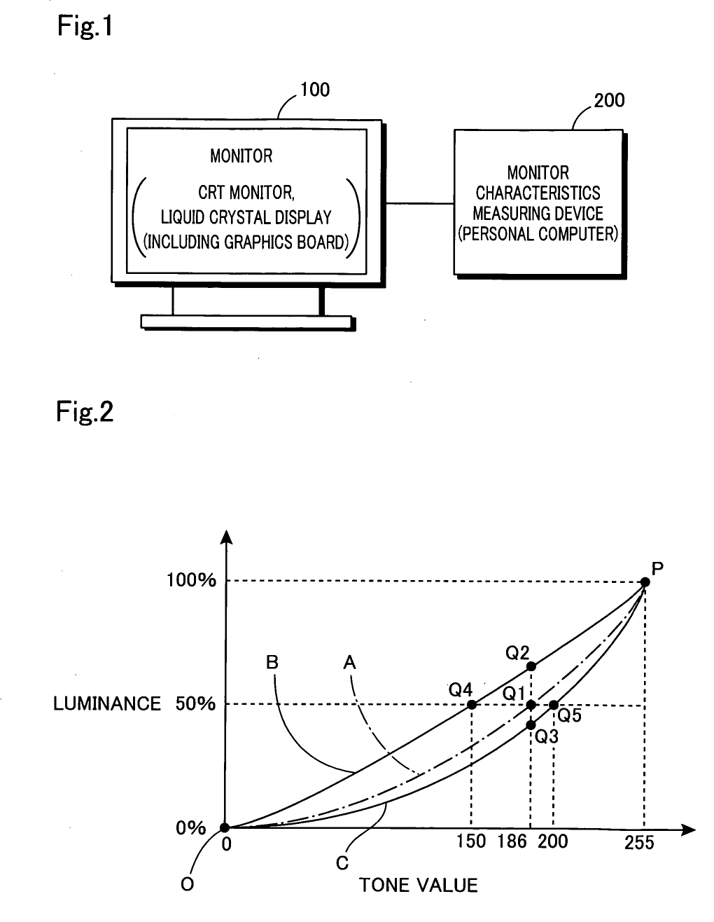

First, the basic principles of a generally-practiced, conventional method for measuring tone reproduction characteristics by visual recognition will be described. As shown in the block diagram of FIG. 1, in order to measure monitor characteristics by visual recognition, a personal computer 200, which is connected to a monitor 100 that is to be measured, can be normally used as a monitor characteristics measuring device. That is, by installing a program for measuring tone reproduction characteristics in personal computer 200 in advance and by making this program operate to make test patterns, to be described later, be displayed on the screen of monitor 100 and obtaining responses from an operator using an input equipment of personal computer 200, the data necessary for measurement can be taken in.

Though a method for measuring tone reproduction characteristics (so-called gamma characteristics), which is directly relevant to the present invention, will be described here, by using personal computer 200 that functions as a monitor characteristics measuring device, the chromaticities of the three primary colors, the chromaticity of white, and other characteristics can also be measured, and such measurement results are generally referred to as monitor profile data based on visual recognition. Monitor 100, which is to be the object of measurement of the profile data, is not limited to a CRT monitor and may also be a liquid crystal display, etc. In the present Specification, the term “monitor” is the same in definition as “display device” and widely refers to devices having a function of displaying an image based on electrical signals. Also, normally in connecting monitor 100 to personal computer 200, a graphics board, which serves as an interface for transferring image signals, is used, and since such a graphics board and other image processing circuits are components that affect the display characteristics of monitor 100, these components make up a portion of the object of measurement by the monitor characteristics measuring device. In other words, with the present invention, “monitor 100” is a concept that includes an image processing circuit, such as a graphics board.

FIG. 2 is a graph showing general tone reproduction characteristics of a monitor. As is illustrated, this tone reproduction characteristics graph indicates the relationship between the tone value of an input signal provided to monitor 100 and the actual display luminance obtained on the screen of monitor 100. Here, for the convenience of description, it will be deemed that the tone value takes on a value among the 256 steps of 0 to 255 expressed by 8-bit data and the luminance is expressed in the range of 0% to 100% (the range from the minimum luminance to the maximum luminance that depends on the ability of the monitor or on a prescribed setting).

In this case, as is illustrated in the graph of the FIGURE, the minimum tone value of 0 and the minimum luminance of 0% coincide (origin O of the graph) and the maximum tone value of 255 and the maximum luminance of 100% coincide (point P of the graph). This is because a circuit of monitor 100 (normally, a circuit on the graphics board) is set so that display at the minimum luminance of 0% is performed when data indicating the minimum tone value of 0 is input and display at the maximum luminance of 100% is performed when data indicating the maximum tone value of 255 is input. However, the relationship of tone values and luminance values in between will not necessarily be a linear relationship. This depends on the characteristics of a D/A conversion circuit on the graphics board and the tone reproduction characteristics normally differ according to the type of each individual monitor, and more strictly speaking, according to each individual lot.

It is known that with a general CRT monitor, the graph indicating the tone reproduction characteristics can be approximated by the function curve, “luminance=(tone value)^{γ}” having the power term, γ. With Windows (registered trade mark), this γ value is recommended to be set to 2.2 in accordance with the “IEC 61966-2-1: Colour Measurement and Management in Multimedia Systems and Equipment—Part 2-1: Default RGB Colour Space—sRGB” standard. Also, with Macintosh (registered trade mark), since there are many applications wherein printing data are displayed on a monitor, it is recommended that a value of 1.8, which is close to the tone reproduction characteristics of printing, is used. Curve A, indicated in the FIGURE by the alternate long and short dash line, indicates the tone reproduction characteristics when γ=2.2. However, curves unique to each individual monitor, such as curves B and C, indicated in the FIGURE by solid lines, are obtained in actuality. Thus when data indicating a tone value of 186 is provided from the personal computer 200 to the monitor 100, a monitor with ideal characteristics, such as indicated by curve A, will provide a luminance value of 50%, which is the ordinate value of point Q1. However, with actual monitors having characteristics indicated by curves B and C, luminance values corresponding to the ordinate values of points Q2 and Q3 are obtained respectively. Put in another way, in order to make a monitor having the characteristics indicated by curve B perform display at the proper luminance of 50% in correspondence to a tone value of 186, a process of correcting the tone value of 186 to a tone value of 150, which corresponds to being the abscissa value of the point Q4, must be performed, and in order to make a monitor having the characteristics indicated by curve C perform display at the proper luminance of 50% in correspondence to a tone value of 186, a process of correcting the tone value of 186 to a tone value of 200, which corresponds to being the abscissa value of the point Q5, must be performed.

Such correction is generally referred to as gamma correction. Consequently, in using monitor 100 upon connection to personal computer 200, etc., a graph indicating the tone reproduction characteristics unique to this monitor 100 must be determined as monitor profile data in advance and gamma correction using these data must be performed.

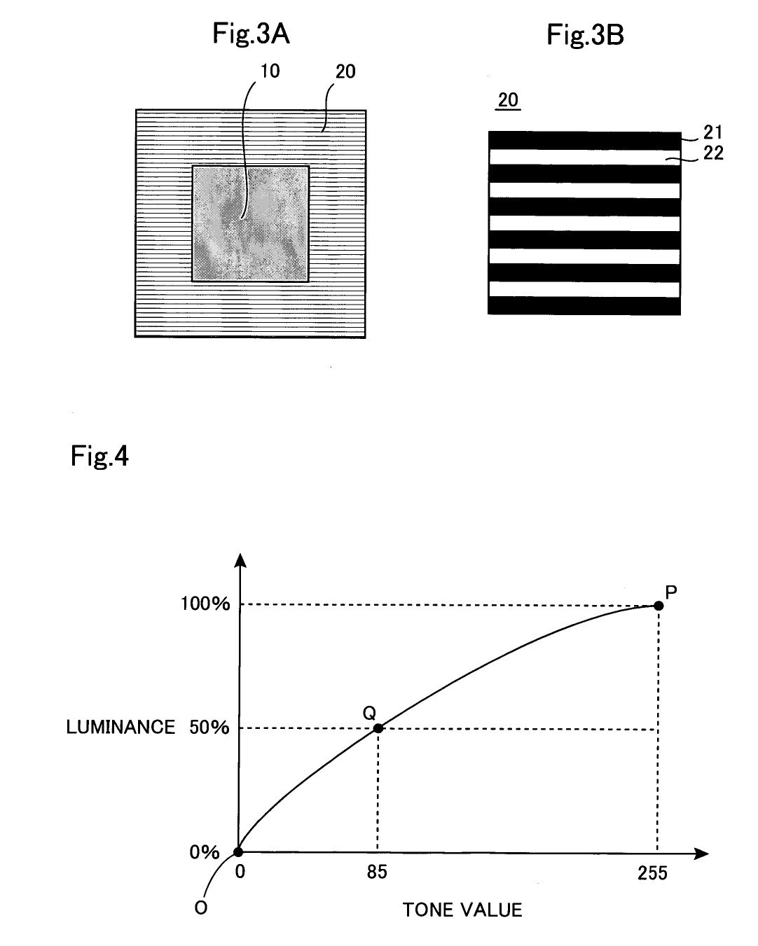

Though as mentioned above, there are methods of using optical measuring devices among methods of measuring the tone reproduction characteristics of each individual monitor, normally, a method of obtaining characteristics data while performing visual recognition with human eyes is employed. FIGS. 3A and 3B are plan views illustrating the general principles of measuring tone reproduction characteristics by visual recognition. With this method, first, a test pattern, such as that shown in FIG. 3A is made to be displayed on the screen of monitor 100 to be measured. This test pattern is made up of a first attribute region 10 and a second attribute region 20. In the illustrated example, first attribute region 10 is a square region and second attribute region 20 is a frame-like region that surrounds this square region. A uniform, even pattern is made to be displayed in first attribute region 10, and a reference pattern, having a prescribed reference luminance, is made to be displayed in second attribute region 20.

As mentioned above, regardless of the curve that indicates the gamma characteristics, the respective ends of the curve are fixed at the points O and P. That is, a region that is provided with data indicating the minimum tone value of 0 is always displayed at the lowest luminance of 0% (totally black) and a region that is provided with data indicating the maximum tone value of 255 is always displayed at the highest luminance of 100% (totally white). Using this property, a reference pattern with a reference luminance that will serve as a basis is displayed in second attribute region 20.

FIG. 3B is a partially enlarged view of second attribute region 20. As illustrated, second attribute region 20 is arranged by alternatingly positioning stripe-like first sub-regions 21 with the minimum tone value of 0 and stripe-like second sub-regions 22 with the maximum tone value of 255. That is, a pattern of a black-and-white stripe design is formed. Here, if the area ratio of first sub-regions 21 and second sub-regions 22 is set to 1:1 (in other words, if the widths of all of the black and white stripes set to be equal), even though the individual sub-regions 21 and 22 are displayed at the lowest luminance of 0% or the highest luminance of 100%, when observed visually from a certain distance, the region will be falsely recognized as being displayed at a luminance of 50%. Obviously, for this purpose, the width dimensions of the black and white stripes must be made small to some degree so that it will be difficult for the naked eye to observe the stripe pattern itself.

Thus in the pattern shown in FIG. 3A, second attribute region 20, which forms the peripheral frame region, functions as a reference pattern that simulates a luminance of 50%. Meanwhile, an uniform, even pattern (in other words, a pattern wherein all pixels have the same tone value) is displayed in first attribute region 10 and the brightness thereof is made adjustable by an input operation by the operator. Then while making the operator view this test pattern, the operator is made to perform an operation of adjusting the tone value of the pixels in first attribute region 10 so that the brightness of first attribute region 10 becomes the same as the brightness of second attribute region 20.

Here, if, for example, the brightness of regions 10 and 20 become the same when the tone value of the pixels inside first attribute region 10 is set to 85, it can be recognized that with this monitor, the tone value corresponding to a reference luminance of 50% is 85. As shown in the graph of FIG. 4, a point Q, having the reference luminance value of 50% and the corresponding tone value of 85 as the respective coordinate values, is then plotted, and the curve that smoothly joins the three points, O, Q, and P, is determined as the curve of the tone reproduction characteristics (gamma characteristics) that are to be determined. Since as mentioned above, the tone reproduction characteristics of a general CRT monitor can be approximated by the function curve, “luminance=(tone value)^{γ},” a curve such as that shown in FIG. 4 can be determined uniquely if three points are determined. Consequently, in order to make the monitor, having the characteristics shown in FIG. 4, perform a display corresponding to a luminance of 50%, data indicating a tone value of 85 is provided.

<<<Section 2. Basic Tone Reproduction Characteristics Measuring Method by This Invention>>>

The above-described conventional method for measuring tone reproduction characteristics has the merit that measurements based on the visual recognition of an operator is enabled and measurement results that match the sensitivity characteristics of human eyes can be obtained. However, with a color monitor used in DTP processes for preparing printed matter, etc., tone reproduction characteristics measurement of higher precision are demanded and adequate measurement results cannot be provided necessarily by the conventional measuring method. Experiments by the inventor of this application have shown that it is difficult to make measurements of adequate precision especially on liquid crystal color displays and on CRT color monitors that have undergone aged deterioration. A main reason for this is considered to be that, with color monitors, tone reproduction characteristics differ according to color.

Generally with a color monitor, since color image display using the three primary colors of R, G, and B is carried out, a separate tone value must be designated for each of the three primary colors, R, G, and B. However, with the conventional tone reproduction characteristic measuring method, there is no concept of measuring separate characteristics according to color and all of the three primary colors are handled together. For example, with a measurement using a test pattern such as that shown in FIG. 3A, brightness adjustment of the interior of first attribute region 10 is performed under the premise of always using tone values in common for the three primary colors, R, G, and B. The tone reproduction characteristics obtained by the conventional method are thus characteristics in common to the three primary colors, R, G, and B, and when tone reproduction characteristics such as those shown in FIG. 4 are obtained, the same characteristics are used to perform gamma correction on all of the three primary colors, R, G, and B.

This was done conventionally since with a general color monitor, it was considered that the tone reproduction characteristics are substantially the same for the three primary colors, R, G, and B. Indeed in the case of CRT color monitors, adjustments are made so that the tone reproduction characteristics of the primary colors, R, G, and B will be substantially the same at the time of product shipment. However, since fluorescent materials undergo degradation due to aged deterioration, the tone reproduction characteristics come to differ according to each primary color. Also in the case of a general liquid crystal color display, the tone reproduction characteristics differ according to each primary color already at the time of product shipment.

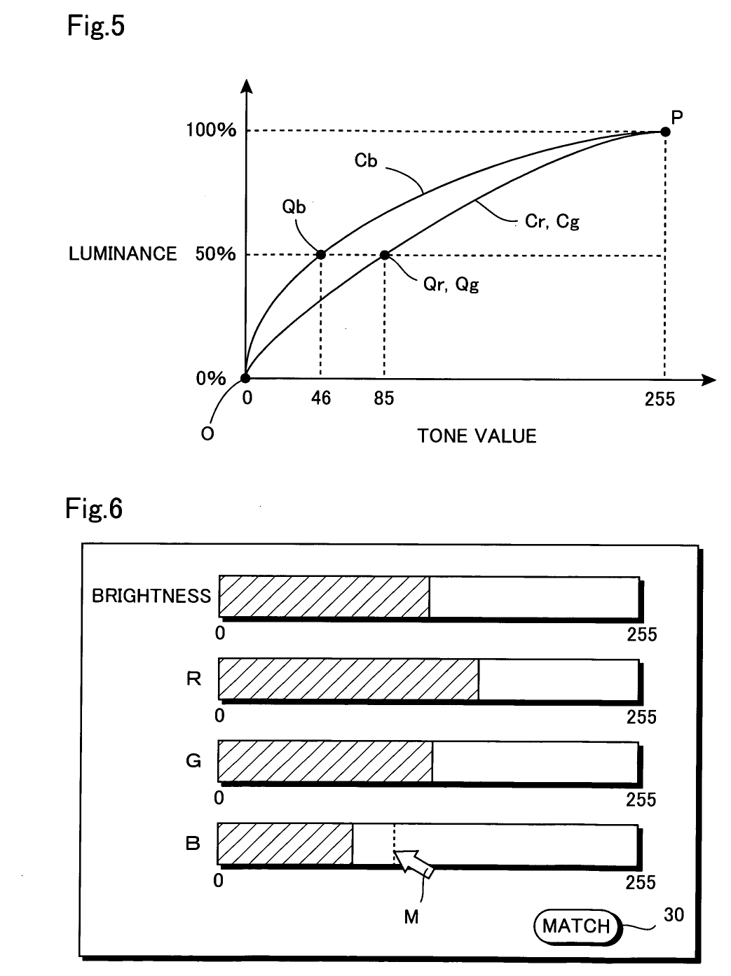

As a result of actually using an optical measuring device and measuring the tone reproduction characteristics according to each primary color of a variety of CRT color monitors and liquid crystal displays made by a variety of manufacturers, the present inventor has found certain trends in common for liquid crystal displays, regardless of old or new and for many of second-hand CRT color monitors. These trends show that, for the three primary colors, R, G, and B, whereas substantially the same tone reproduction characteristics are obtained for the primary color R (red) and the primary color G (green), different tone reproduction characteristics are obtained for the primary color B (blue). To be more specific, for many liquid crystal color monitors, tone reproduction characteristics of the trends shown in FIG. 5 are obtained. In the illustrated example, curves Cr, Cg, and Cb are the tone reproduction characteristics that are measured for the primary colors R, G, and B, respectively. Though curves Cr and Cg are the same, curve Cb is somewhat shifted upwards. Oppositely with second-hand CRT color monitors, just curve Cb is somewhat shifted downwards.

Though the reason as to why such common trends appear has not yet been analyzed theoretically, in view that the same trends are seemed to be seen with all models of all manufacturers, these trends can be considered to be universal trends that are seen substantially in common among color monitors using the three primary colors R, G, and B. The inventor considers that in the case of liquid crystal color monitors, the above trend appears due to the properties of the liquid crystal material and the optical characteristics of the polarizing plate, and considers that in the case of second-hand CRT color monitors, the above trend appears due to the degradation of the fluorescent material for blue being more severe than the degradations of the fluorescent materials for red and green. Consequently, as shown in the FIG. 5, in order to make a color monitor perform a gray display of a luminance of 50%, 85, which is the abscissa value of the points Qr and Qg, must be provided as the tone value for the primary colors R and G, while providing 46, which is the abscissa value of point Qb, as the tone value for the primary color B.

The basic philosophy of this invention is to determine tone reproduction characteristics according to each of the three primary colors, R, G, and B, separately and independently or at least determine tone reproduction characteristics for the primary colors R and G and tone reproduction characteristics for the primary color B separately and independently on the basis of the above facts to enable tone reproduction characteristics to be measured at high precision.

The tone reproduction characteristics measuring device for color monitor of the present invention is a device for determining, by visual recognition, the tone reproduction characteristics, which indicate the relationship between input signal tone values and actual display luminance, of a color monitor having a function of displaying color images using the three primary colors, R, G, and B, and as with the conventional measuring method described in Section 1, the basic principle thereof is to use a test pattern such as that shown in FIG. 3A. However, in order to determine different tone reproduction characteristics according to color, the following measures are taken with this invention.

That is, an even pattern of uniform brightness and color is made to be displayed at all times in first attribute region 10, and the brightness and color of this even pattern are varied based on operations of an operator or varied automatically based on prescribed rules. This method is new in that not just the variation of brightness but the variation of color, which is not carried out in conventional methods, is carried out. The operator then compares first attribute region 10 and second attribute region 20 visually and continues varying the brightness and color in regard to first attribute region 10 until it is recognized that both regions are matched in brightness and color.

Though this variation of brightness and variation of color can, in principle, be carried out simultaneously, for practical use, preferably a brightness varying operation and a color varying operation are arranged to be performed separately and independently and the operator is made to perform recognition of the matching of brightness during the brightness varying operation and perform recognition of the matching of color during the color varying operation.

The brightness varying operation can be performed by a task of increasing or decreasing the tone values of all of the three primary colors, R, G, and B, by a common variation amount. For example, when in a state wherein a prescribed even pattern is displayed in first attribute region 10 using the tone values, R=120, G=120, and B=120, if each tone value is increased by a common variation amount S=5, the tone values become R=125, G=125, and B=125, and the luminance of the even pattern displayed in first attribute region 10 is thus increased slightly. Oppositely, by decreasing each tone value by the common variation amount S=5, the tone values become R=115, G=115, and B=115, and the luminance of the even pattern displayed in first attribute region 10 is thus decreased slightly. Such a brightness varying operation can be said to be mainly an operation of varying the brightness of an even pattern without hardly giving rise to a color variation that can be recognized visually (though strictly speaking, there is a possibility that a color variation will be recognized).

Meanwhile, the color varying operation can be performed by a task of increasing or decreasing the tone value of one of the three primary colors, R, G, and B. For example, when in a state wherein a prescribed even pattern is displayed in first attribute region 10 using the tone values, R=120, G=120, and B=120, the tone value concerning a specific color R is increased by just a variation amount S=5, the tone values become R=125, G=120 and B=120 and the redness of the even pattern displayed in first attribute region 10 can thus be strengthened slightly. Oppositely, by performing by decreasing by the variation amount S=5, the tone values become R=115, G=120, and B=120, and the redness of the even pattern displayed in first attribute region 10 can thus be weakened slightly. With such a color varying operation, there is little variation of brightness that can be recognized visually and the operation can be said to be mainly an operation of varying the color of an even pattern.

In order to vary tone values based on operation inputs by the operator, an operation panel, such as that shown in FIG. 6, is made to be displayed on the screen to enable adjustment of the tone values of the respective primary colors by mouse operation, etc., by the operator. With this operation panel, the brightness varying operation and the color varying operation can be performed separately and independently. That is, each of the four horizontal bars that make up this operation panel is a bar indicating a certain tone value within the range of 0 to 255, and the right end position of the bar with the hatching indicates the certain tone value. The right end position of each bar can be modified instantly to a position that is clicked by a mouse cursor M, and the operator can set the right end positions of the four bars at any arbitrary position.

The bars indicated as “R,” “G,” and “B” in the FIGURE are bars for setting the tone values of the primary colors, R, G, and B, respectively. Meanwhile, the bar indicated as “Brightness” is a bar that constantly indicates the average of the tone values of the primary colors, R, G, and B, at that point. Thus when a tone value of any of the bars indicated as “R,” “G,” and “B” is modified (modification of the right end position), the tone value of the bar indicated as “Brightness” is also modified instantly in conjunction. Oppositely, when tone value of the bar indicated as “Brightness” is modified, the tone values of the respective bars indicated as “R,” “G,” and “B” are modified instantly in conjunction by amounts that are in accordance with the modification (for example, the variation amount with respect to the “Brightness” bar may be distributed in accordance with proportional ratios that correspond to the tone values of the respective bars).

By using such an operation panel, the operator performs the operation of modifying the tone value of the bar indicated as “Brightness” to perform the brightness varying operation and performs the operation of modifying the tone values of any of the bars indicated as “R,” “G,” and “B” to perform the color varying operation. For example, to perform a varying operation of making the brightness brighter, a position further to the right of the right end of the bar indicated as “Brightness” is clicked by the mouse, and to perform a varying operation of weakening the redness slightly, a position slightly to the left of the right end of the bar indicated as “R” is clicked by the mouse.

By making the operation panel shown in FIG. 6 be displayed near the test pattern shown in FIG. 3A and making the operator perform the brightness varying operation and color varying operation to thereby perform adjustment to make first attribute region 10 and second attribute region 20 be matched in brightness and color, the tone reproduction characteristics of each primary color of the three primary colors, R, G, and B, can be determined separately and independently. For example, consider a case where, in the state in which a reference pattern corresponding to a luminance of 50% is displayed inside second attribute region 20, the operator recognizes that the regions are matched both in brightness and color. The operator is then made to click on a match button 30 when the matching of both the brightness and the color are thus recognized. If at this point, the tone values indicated by the respective bars indicated as “R,” “G,” and “B” in the operation panel shown in FIG. 6 are R=85, G=85, and B=46, curves Cr, Cg, and Cb, showing the tone reproduction characteristics of the respective primary colors, are obtained as shown in FIG. 5.

However, in terms of practical use, the operations of varying the tone values using the operation panel shown in FIG. 6 are difficult to perform unless the operator is an expert. This is because though a general operator can recognize that “first attribute region 10 and second attribute region 20 differ slightly in color,” he/she cannot make the judgment of “which color component among the three primary colors should be increased or decreased to obtain the same color.” Thus in the case where a measurement using the operation panel shown in FIG. 6 is carried out, though tone reproduction characteristics can be determined for all of the three primary colors, R, G, and B separately and independently, a burden in terms of measurement operation is placed on the operator. The root cause is that the four parameters of brightness, the primary color R, primary color G, and primary color B are the objects of adjustment.

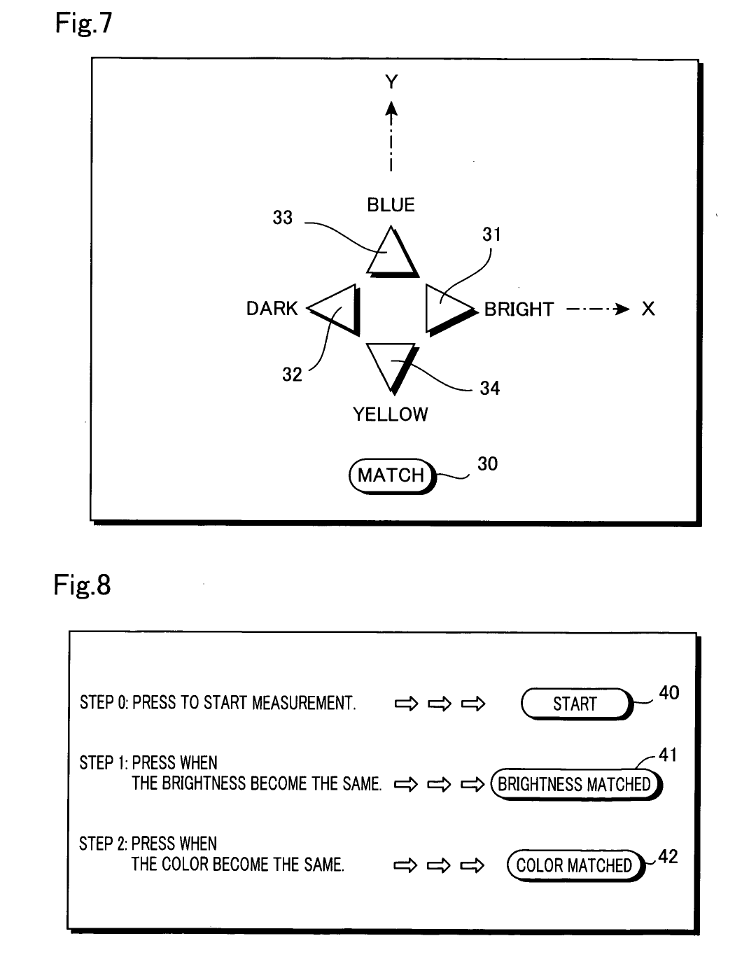

The present inventor has thus conceived a practical operation panel, which is shown in FIG. 7. This operation panel has four adjusting buttons 31 to 34 and a match button 30. The four adjusting buttons 31 to 34 are positioned so that when a two-dimensional XY coordinate system, such as illustrated on the plane on which the respective buttons are positioned, is defined (such a coordinate system is not displayed on the actual operation panel), first button 31 and second button 32 are positioned at opposing positions along the X-axis that sandwich the origin, and third button 33 and fourth button 34 are positioned at opposing positions along the Y-axis that sandwich the origin. Though the four adjusting buttons 31 to 34 have triangular shapes in this example, these do not need to be triangular in shape.

Here, first button 31 is a button that provides an instruction of making the even pattern displayed inside first attribute region 10 brighter, second button 32 is a button that provides an instruction of making the even pattern darker, third button 33 is a button that provides an instruction of strengthening the component of a specific color of the even pattern, and fourth button 34 is a button that provides an instruction of weakening the component of a specific color of the even pattern. In the present example, the primary color B is set as the specific color.

The relationship between the operations of the respective buttons and the operation of varying the tone values of the respective primary colors is as follows. First, when there is an operation input (for example, a mouse click) for first button 31, an operation of adding a common variation amount to all of the tone values of the three primary colors, R, G, and B is performed, and when there is an operation input for second button 32, an operation of subtracting the common variation amount from all of the tone values of the three primary colors, R, G, and B is performed. When there is an operation input for third button 33, an operation of adding a prescribed variation amount to the tone value of the specific color (the primary color B in the present example) is performed, and when there is an operation input for fourth button 34, an operation of subtracting the prescribed variation amount from the tone value of the specific color is performed.

For example, when the variation amount S is set to 5, each time first button 31 is clicked, a modification of increasing all tone values of the three primary colors, R, G, and B by just 5 is performed, and each time second button 32 is clicked, a modification of decreasing all tone values of the three primary colors, R, G, and B by just 5 is performed. Likewise, each time third button 33 is clicked, a modification of increasing the tone value of just the primary color B, which is the specific color, by just 5 is performed, and each time fourth button 34 is clicked, a modification of decreasing the tone value of just the primary color B by just 5 is performed. Obviously, since the allowable range of the respective tone values is 0 to 255, modifications beyond the minimum tone value of 0 and the maximum tone value of 255 cannot be performed.

The object of adjustment in the operation panel shown in FIG. 7 will thus be just the two parameters of brightness and the primary color B. Moreover, since the operation system is one where the adjustment of the brightness parameter is performed by operations in the X-axis direction and the adjustment of the primary color B parameter is performed by operations in the Y-axis direction and these can thus be grasped intuitively, the operability is improved extremely in comparison to the operation panel shown in FIG. 6. First button 31 and second button 32 are buttons for performing the brightness varying operation wherein the tone values are varied primarily so that the brightness of the even pattern will change, and third button 33 and fourth button 34 are buttons for performing the color varying operation wherein a tone value is varied primarily so that the color of the even pattern will change.

The characters of “Bright,” “Dark,” “Blue,” and “Yellow” are indicated near the respective buttons 31 to 34 to provide an intuitive guideline to the operator. That is, the operator clicks first button 31 to make a modification of making the pattern brighter, clicks second button 32 to make a modification of making the pattern darker, clicks third button 33 to make the pattern bluer (increase the blue component), and clicks fourth button 34 to make the pattern more yellow (decrease the blue component). And in the final stage when it is recognized that matching of both brightness and color is achieved, match button 30 is clicked.

With the operation panel shown in FIG. 7, the tone values of the respective three primary colors, R, G, and B cannot be set independently of each other and the tone values of the primary color R and the primary color G will constantly be the same. Thus not all of the tone value reproduction characteristics of the three primary colors R, G, and B can be determined separately and independently according to the primary colors. However, since the tone value of primary color B, which is set as the specific color, can be set to differ from the tone values of the other primary colors R and G, it is possible to determine the tone reproduction characteristics of the primary colors R and G and the tone reproduction characteristics of the primary color B separately and independently.

As was described above based on the graph of FIG. 5, with many color monitors, whereas substantially the same tone reproduction characteristics are obtained for the primary color R and the primary color G among the three primary colors, R, G, and B, different tone reproduction characteristics are obtained for the primary color B. Thus if it is premised that characteristics are to measured for a color monitor with such trends, problems in terms of practical use will not arise even when tone value varying operations are performed by the operation panel shown in FIG. 7. That is, with the operation panel shown in FIG. 7, the primary color B is set as the specific color among the three primary colors, R, G, and B, and a curve indicating the tone reproduction characteristics for the primary color B and a curve indicating the tone reproduction characteristics in common for the primary colors R and G can be determined separately.

The variation amount S, by which a tone value is increased or decreased by the clicking of a button, may be made switchable in an arbitrary manner. For example, a method may be employed wherein a rough adjustment setting with the variation amount S=5 and fine adjustment setting with the variation amount S=1 are provided, a rough tone value varying operation is performed with the rough adjustment setting in the initial stages, and the fine adjustment setting is switched to at the point at which the brightness and color are recognized as having become close to some degree to continue with a fine tone value varying operation using the fine variation amount.

It is also possible to provide an arrangement wherein the variation amount is changed according to the location of clicking of each button. For example, if an arrangement is made so that when a tip portion (portion away from the origin of the XY coordinate system) of the triangular shape that makes up each of buttons 31 to 34 is clicked, a tone value varying operation of a large variation amount (for example, of the variation amount S=5) will be performed, and when a base portion (portion close to the origin of the XY coordinate system) of the triangular shape is clicked, a tone value varying operation of a small variation amount (for example, of the variation amount S=1) will be performed, the operator will be enabled to perform the measurement tasks efficiently by performing clicking operations suitably in accordance with the required variation amounts.

<<<Section 3. Automatic Tone Value Varying Method>>>

In Section 2 above, an example was described wherein tone value varying operations are performed by making the operator perform operation inputs for varying the brightness and color using an operation panel such as shown in FIG. 6 or 7. In particular, by using the operation panel shown in FIG. 7, since just adjustment operations concerning the two parameters of bright/dark and bluish/yellowish need to be performed, the work load of the operator is lightened significantly in comparison to the case of using the operation panel shown in FIG. 6. However, regardless of which operation panel is used, the operator him/herself must perform operation inputs in directions in which the brightness and color will become matched.

Here, a method of lightening the burden of such operation inputs further will be described. The main features of this method are that the tone values of the even pattern displayed inside first attribute region 10 are made to vary automatically with time in accordance with prescribed rules that are established in advance and the operator is made to make a notification by clicking a match button, etc., when he/she recognizes that the brightness and color of the even pattern match those of the reference pattern. Here, the rules for automatically varying the tone values with time may be any rules as long as they are rules by which the brightness and color will vary within the required ranges, for practical use, rules by which the two types of varying operations of the brightness varying operation and the color varying operation are executed separately are preferable.

Specifically, arrangements are made to perform the two types of varying operation of the brightness varying operation, wherein a common variation amount is added to or subtracted from all of the respective tone values of the three primary colors, R, G, and B, at a prescribed timing to thereby change the tone values so that mainly the brightness of the even pattern changes, and the color varying operation, wherein a prescribed variation amount is added to or subtracted from the tone value of one specific color among the three primary colors, R, G, and B (as mentioned above, for practical use, the primary color B is preferably set as the specific color) at a prescribed timing to thereby change the tone value so that mainly the color of the even pattern changes.

The above-described brightness varying operation corresponds to automatically clicking first button 31 or second button 32 of the operation panel shown in FIG. 7 at the prescribed timing. For example, if a common variation amount S=+5 (+ indicates that the tone values are to be increased) is set and a repetition cycle of 1 second is set as the prescribed timing, all of the respective tone values of the three primary colors, R, G, and B are increased by 5 automatically every 1 second. Or, if a common variation amount S=−6 (− indicates that the tone values are to be decreased) is set and a repetition cycle of 2 seconds is set as the prescribed timing, all of the respective tone values of the three primary colors, R, G, and B are decreased by 6 automatically every 2 seconds.

Since the respective tone values can only take on values within the allowable range of 0 to 255, when the tone value obtained by the varying operation of adding the variation amount exceeds the maximum tone value of 255, a circulation process of incrementing the minimum tone value of 0 by the excess amount is performed, and when the tone value obtained by the varying operation of subtracting a variation amount falls below the minimum tone value of 0, a circulation process of decrementing the maximum tone value of 255 by the excess amount is performed. For example, though when a variation amount of 5 is added to a tone value of 253, the tone value will be 258, in this case, the tone value of 2, which is obtained by subtracting 256, is used instead. That is, circulation of the tone values in the manner of 255→0 is performed so that the tone value for the excess 3 steps is counted as 0, 1, 2, from the minimum tone value of 0. Likewise, though in the case where the variation amount of 6 is subtracted from a tone value of 2, the subtraction result is −4, the tone value of 252, which is obtained by adding 256, is used instead. That is, circulation of the tone values in the manner of 0→255 is performed so that the tone value for the excess 4 steps is counted as 255, 254, 253, 252, from the maximum tone value of 255.

Though the initial tone values of the respective primary colors in such a brightness varying operation may be set arbitrarily, for practical use, the initial tone values of the three primary colors are set to a prescribed common value. For example, when R=0, G=0, and B=0 are set as initial values and variation by a common variation amount S=+5 is performed, the tone value of each primary color will vary automatically in the manner of 0→5→10→15→ . . . 250→255→4→9→14→ . . . . When such a varying operation is performed automatically, the even pattern inside first attribute region 10 will be observed by the operator as varying with time in the manner of totally black→dark gray→intermediate gray→light gray→white→totally black→ . . . . Since the reference pattern of a luminance of 50% is displayed inside second attribute region 20, the operator will recognize that the even pattern is matched in brightness with the reference pattern at the point at which the even pattern becomes an intermediate gray. The operator is made to perform the input indicating the matching of brightness (for example, the clicking of a brightness match button) at the point of recognizing that the brightness is matched.

Needless to say, since this operation is performed by a human being, the decision of recognition of matching may be delayed and thus the timing at which the matching input operation is performed may be missed. In this case, though the even pattern will go past intermediate gray and change to becoming light gray, it will eventually circulate back to the black state and the opportunity for performing the matching input operation for intermediate gray will arrive again. By thus employing a method of varying the tone values in a repeatedly circulating manner, the operator is provided with the opportunity of performing the matching input operation several times and a more accurate matching input can thus be anticipated. Actually, after a few times of circulation, the operator will come to sensually grasp the cycle of tone change and will finally able to perform an accurate matching input operation.

If the varying amount S is set to a somewhat large value, there may be cases where the operator will not be able to visually recognize complete matching. In this case, the operator is made to perform the input indicating the recognition of matching when the patterns become closest to each other. This applies not just to the recognition of matching of brightness but also to the recognition of matching of color as will be described below. That is, with the present invention, “recognition of matching” by an operator does not necessarily mean the recognition of complete matching but covers the range of recognition wherein, under prescribed conditions, it is judged that the brightness and color of the patterns have become closest. In actuality, matching is recognized when the contour of first attribute region 10 appears to have become embedded and dissolved inside second attribute region 20.

Though the brightness varying operation has been described above, the color varying operation is nearly the same. The color varying operation corresponds to automatically clicking third button 33 or fourth button 34 of the operation panel shown in FIG. 7 at the prescribed timing. For example, if a common variation amount S=+5 is set and a repetition cycle of 1 second is set as the prescribed timing, just the tone value of the specific color among the three primary colors, R, G, and B is increased by 5 automatically every 1 second. If the primary color B is set as the specific color, the color of the even pattern will gradually increase in blueness. Needless to say, since a circulation process is performed so that the tone value will remain within the allowed range of 0 to 255 in this color varying operation as well, immediately after the state of maximum blueness is reached, the state of maximum yellowness (minimum blueness) is entered. The tone values of the primary colors R and G are kept fixed.

When the color varying operation is thus performed automatically, the even pattern inside first attribute region 10 will be observed by the operator to circulate in the manner of gradually lessening in yellowness from a color strong in yellowness, then after becoming nearly achromatic, gradually becoming stronger in blueness, and then after reaching the state of maximum blueness, returning to the color strong in yellowness. Since the achromatic reference pattern of a luminance of 50% is displayed inside second attribute region 20, the operator will recognize the matching of color with the reference pattern at around the point at which the extremely pale color of the even pattern changes from being yellowish to being bluish. The operator is made to perform an input indicating the matching of color (for example, the clicking of a color match button) at the point of recognizing the matching of color.

Since this judgment of color matching will also be an extremely delicate sensory judgment on the part of the operator, the operator may miss the timing at which the matching input operation is to be performed. However, as with the transition of brightness, the transition of color is also circulated and performed repeatedly, the opportunity for performing the matching input operation will arrive repeatedly so that an accurate matching input operation will be enabled in the final stage.

FIG. 8 is a diagram showing an example of an operation panel used for making the operator perform the brightness matching input operation and the color matching input operation while the brightness varying operation and the color varying operation are executed automatically based on prescribed rules in accordance with the above-described principles. As illustrated, the buttons operated by the operator are the three types of a start button 40, brightness match button 41, and color match button 42, and at the sides of the respective buttons are provided explanatory texts for the respective operations. By making an operation panel such as shown in FIG. 8 be displayed near the test pattern shown in FIG. 3A and making the operator click the respective buttons using a mouse, etc., the series of measurement tasks are completed.

That is, first, the operator clicks start button 40 in accordance with the explanatory text indicated as “Step 0.” The above-described automatic brightness varying operation is thereby executed and the brightness of the even pattern inside first attribute region 10 begins to vary with time. Then in accordance with the explanatory text indicated as “Step 1,” the operator clicks brightness match button 41 at the point at which he/she feels that the brightness of the even pattern has become the same as the brightness of the reference pattern. The above-described automatic color varying operation is then executed, and the color (the color in regard to the primary color B) of the even pattern begins to vary with time. Then in accordance with the explanatory text indicated as “Step 2,” the operator clicks color match button 42 at the point at which he/she feels that the color of the even pattern has become the same as the color of the reference pattern.

The series of measurement tasks are completed by the above procedure. Each of the respective tone values of the three primary colors, R, G, and B at the point at which color match button 42 has been clicked (in the case of this example, the values for R and G will be the same), is then deemed to be the tone value of the corresponding primary color for the reference luminance of 50% and plotted as point Q in FIG. 4 and the tone reproduction characteristics curve is determined for each primary color (the curves for R and G will be the same).

Brightness match button 41 shown in FIG. 8 thus functions as a brightness coincidence signal input means for inputting a brightness coincidence signal that indicates that the operator has recognized the matching of brightness while performing the brightness varying operation, and color match button 42 functions as a color coincidence signal input means for inputting a color coincidence signal that indicates that the operator has recognized the matching of color while performing the color varying operation. And when the inputs of both the brightness coincidence signal and the color coincidence signal are completed, it is deemed that a coincidence signal, indicating the recognition that both the brightness and the color are matched, is input and the tone reproduction characteristics are determined according to the respective primary colors. In the above-described example, the primary color B, among the three primary colors, R, G, and B, is set as the specific color and a curve indicating the tone reproduction characteristics of the primary color B and a curve indicating the common tone reproduction characteristics of the primary colors R and G are determined separately of each other.

Though with the example using the operation panel shown in FIG. 8, the input operation of the brightness coincidence signal and the input operation of the color coincidence signal are performed once each to complete the measurement tasks, for practical use, an embodiment wherein such operations are executed repeatedly in alternation is preferable. A first reason for this is that the matching recognition operation is a sensory operation based on human vision and it may not be possible to perform recognition accurately with a single input operation. Secondly, the brightness varying operation is not necessarily an operation of varying just the brightness and the color varying operation is not necessarily an operation of varying just the color. For example, with the operation panel of FIG. 8, even if the brightness is matched accurately at the point at which brightness match button 41 is clicked, since not just the color but the brightness is also be varied by the subsequently executed color varying operation, the brightness-matched state will be disrupted. In order to avoid such a problem, it is effective to execute the brightness matching operation and color matching operation repeatedly in alternation and it is especially effective to execute the operations repeatedly while gradually decreasing the tone value variation amount.

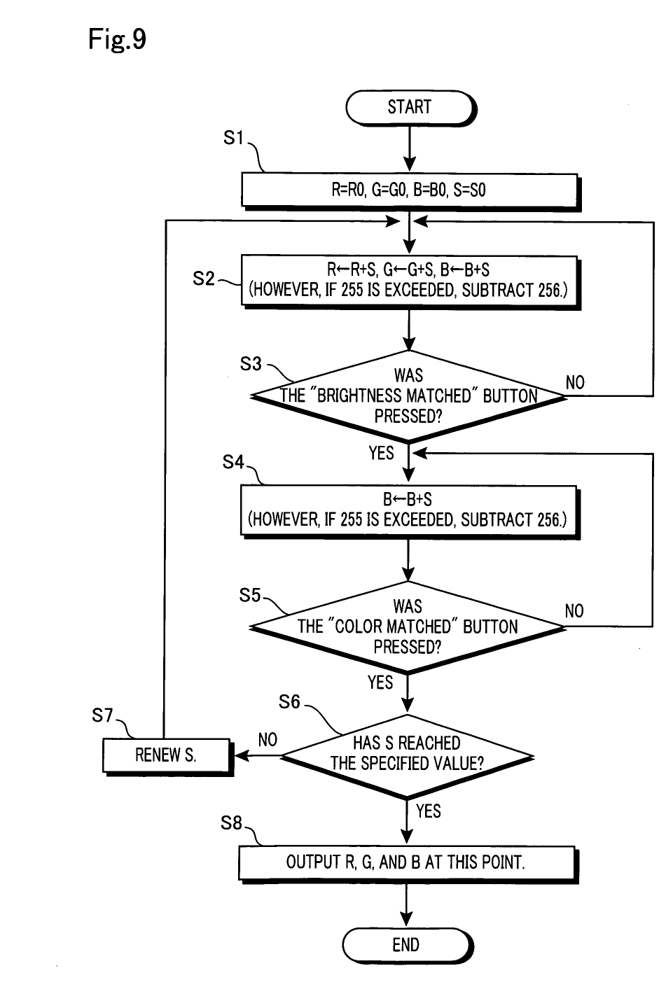

Specifically, the process illustrated by the flowchart of FIG. 9 is performed. First in step S1, the initial values of the respective tone values of the three primary colors R, G, and B and the initial value of the variation amount S is set. In the illustrated example, the respective values are set to R0, G0, B0, and S0.

Then in steps S2 and S3, the operation of matching the brightness is executed. That is, in step S2, the process of adding the variation amount S to each of the tone values of the three primary colors, R, G, and B is performed. However, since the above-described circulation process is performed, when a tone value exceeds 255, 256 is subtracted therefrom. Then in step S3, whether or not the brightness match button has been pressed is judged, and if it has not been pressed, a return to step S2 is performed and the tone values are renewed. The processes of steps S2 and S3 are thus repeated until the brightness match button is pressed. Needless to say, the cycle of this repeated process is set for example to every one second or other time period that is adequate for the operator to make a matching recognition judgment.

If in step S3, the pressing of the brightness match button is detected, the operation of matching the color is executed in steps S4 and S5. That is, firstly in step S4, the process of adding the variation amount S to just the tone value of the specific color B is performed. Since the circulation process is performed here as well, when the tone value exceeds 255, 256 is subtracted therefrom. Then in step S5, whether or not the color match button (which may be used in common as the brightness match button as well) has been pressed is judged, and if it has not been pressed, a return to step S4 is performed and the tone value of the specific color B is renewed. The processes of steps S4 and S5 are thus repeated until the color match button is pressed. The cycle of this repeated process is also set for example to every one second or other time period that is adequate for the operator to make a matching recognition judgment.

If in step S5, the pressing of the color match button is detected, though this means that both the brightness coincidence signal and the color coincidence signal have been input tentatively from the operator, the finalization of the tone values that are to be the measurement results is not performed at this point, and the procedures from step S2 onwards are executed again via step S6 and step S7. Moreover, in step S7, a renewal process of decreasing the variation amount S is executed. The variation amount S that is added in steps S2 and S4 in the second round is smaller than the value used in the first round, thus enabling finer judgment of matching. The process is repeated three times, four times, etc., as necessary while making the variation amount S even smaller.

For example, in the case where the initial value S0 of the variation amount S is set to +5, this is renewed by decreasing by 2 at a time in step S7, and the specified value of the variation amount S for step S6 is set to 1, the variation amount S=+5 in the first round, the variation amount S=+3 in the second round, the variation amount S=+1 in the third round, and after the third time around, the repeated process is completed. When the variation amount S has reached the specified value that had been set in advance, step S8 is entered from step S6 and the respective tone values of the three primary colors, R, G, and B, at that point are output. These tone values are used as the corresponding tone values corresponding to a reference luminance of 50% to determine the tone reproduction characteristics according to the respective primary colors as described above.

With the procedure in FIG. 9, the recognition of matching in the first round and the recognition of matching in the second round differ greatly in recognition conditions. For example, though the recognition of matching in step S3 in the first round indicates that the brightness has tentatively reached a matched state of some level, the matching of color is not considered at all at that point. However, in the recognition of matching in step S3 in the second round, since the recognition of brightness matching is premised on the completion of the recognition of color matching in step S5 of the first round, a more preferable matching state will be obtained in terms of the essential purpose of matching both the brightness and the color. Also, since the variation amount S is decreased to enable finer recognition of matching on each successive round, an even more preferable matching state will be obtained by the recognition of matching in step S3 of the third round than by the recognition of matching in step S3 of the second round.

The procedure illustrated by the flowchart of FIG. 9 can thus be said to be a process wherein, when in the state of performing the brightness varying operation (step S2), the brightness coincidence signal is input (step S3), the color varying operation is started (step S4), and when in the state of performing this color varying operation (step S4), the color coincidence signal is input (step S5), the brightness varying operation (step S2) is started, and the brightness varying operation and color varying operation are executed repeatedly in alternation while gradually decreasing the variation amount S of the tone values (step S7). And when the input of both the brightness coincidence signal and the color coincidence signal is completed after the variation amount S has reached the prescribed specific value, it is deemed that the coincidence signal indicating the recognition that both the brightness and the color are matched is input.

A negative value may be set as the variation amount S. In this case, since the tone values after variation are practically determined by subtraction in steps S2 and S4, a process of adding 256 is performed when the tone value after variation becomes a negative value. Needless to say, in step S7, renewal is performed so that the absolute value of the variation amount S decreases gradually.

Though in the above-described embodiment, the repeated variation of the tone values is performed as a circulating motion of 0˜255→0˜255→0˜255 . . . , this repeated variation of the tone values may be a reciprocating motion instead. In this case, at the point at which a varied value that exceeds or falls below the maximum tone value or minimum tone value is obtained, a fold-back process is performed and the sign of the variation amount S is inverted. Specifically, when as a result of increasing a tone value gradually by a positive variation amount +S, the maximum tone value of 255 is exceeded, the sign of the variation amount is inverted and the tone value is decreased gradually by the negative variation amount −S, and when consequently the tone value falls below the minimum tone value of 0, the sign of the variation amount is inverted and the tone value is increased gradually again by the positive variation amount +S. A process of gradually increasing the tone value from 0 to 255 and a process of gradually decreasing the tone value from 255 to 0 are thus performed in alternation.

Furthermore, though in above-described examples, regardless of performing the repeated variation of the tone values in the form of circulating motion or reciprocating motion, the tone values are varied over the entire allowable range of 0 to 255, for practical use, variation over this entire range is not necessary. For example, in the case where the tone reproduction characteristics of the monitor, which is the object of measurement, exhibit the curves shown in FIG. 5, the tone values of R=85, G=85, and B=46 will be obtained in the final stage as the corresponding tone values corresponding to a reference luminance of 50%. These values are considerably biased towards the 0 side with respect to the central value of 128 of the range of 0 to 255. However, with a general monitor, it is quite unlikely in practical terms that values such as 10 and 20 or 240 and 250 will be obtained as the corresponding tone values corresponding to a reference luminance of 50%. Thus for practical use, the circulating motion or reciprocating motion may be carried out in a limited range, such as 30 to 230.

Also in the case of performing processes repeatedly while gradually decreasing the variation amount S as in the procedure illustrated in FIG. 9, more efficient measurement tasks will be enabled by narrowing the range of variation of the tone values to be subject to circulating motion or reciprocating motion at the same time as decreasing the variation amount S. For example, in steps S2 and S4 of the first round in which the variation amount S is set to +5, the tone value variation range is set to the entire allowable range of 0 to 255. Then in steps S2 and S4 of the second round in which the variation amount S is set to +3, the tone value variation ranges are narrowed to the ranges of±30 centered about the tone values prior to variation.

By doing so, if at the point at which the first round is ended, the results, R=90, G=90, and B=50 are obtained, variations within the limited ranges of R=60 to 120, G=60 to 120, and B=20 to 80 are performed in step S2 of the second round. Since roughly approximate values (the values of R=90, G=90, and B=50 in the present example) are obtained in the first round processes as the tone values of the respective primary colors for which the matching of brightness and color are anticipated, it can be said that it is adequate to perform variations within the ranges of±30 centered about these roughly approximate values in the second round. It is inefficient to vary the tone values to values for which there is absolutely no possibility of matching. Likewise, in the third round, for example, the variation amount S is set to +1 and variations within ranges of±10 centered about the tone values prior to variation are carried out.

<<<Section 4. Method of Plotting More Points>>>

As mentioned in Section 1, in order to determine tone reproduction characteristics as in the graph of FIG. 4, a point Q, besides the respective end points O and P of the graph, is plotted and an approximate function curve that passes through the three points, O, P, and Q is determined by computation. Also as mentioned above, in order to determine the position of point Q by measurement by visual recognition, a method is employed wherein a test pattern such as that shown in FIG. 3A is used, a reference pattern, which is formed of black and white stripes as shown in FIG. 3B and corresponds to a reference luminance of 50%, is displayed inside second attribute 20, and the sameness with respect to the even pattern inside first attribute region 10 is confirmed visually.

The tone reproduction characteristics (gamma characteristics) can be determined as an approximate function curve that passes through the three points O, P, and Q since it is known that the tone reproduction characteristics of a general CRT monitor is a function curve of the form, “luminance=(tone value)^{γ},” having the power term, γ. This is because, in the first place, the relationship “L=E^{γ},” holds between the voltage E that is applied to a cathode ray tube and the emitted light output L. Thus in the case of a monitor that uses a cathode ray tube, it is sufficient to use a reference pattern corresponding to a reference luminance of 50% to measure the corresponding tone value and plot the point Q. However, with a liquid crystal display, etc., the tone reproduction characteristics will not necessarily be a function curve having the power term, γ.

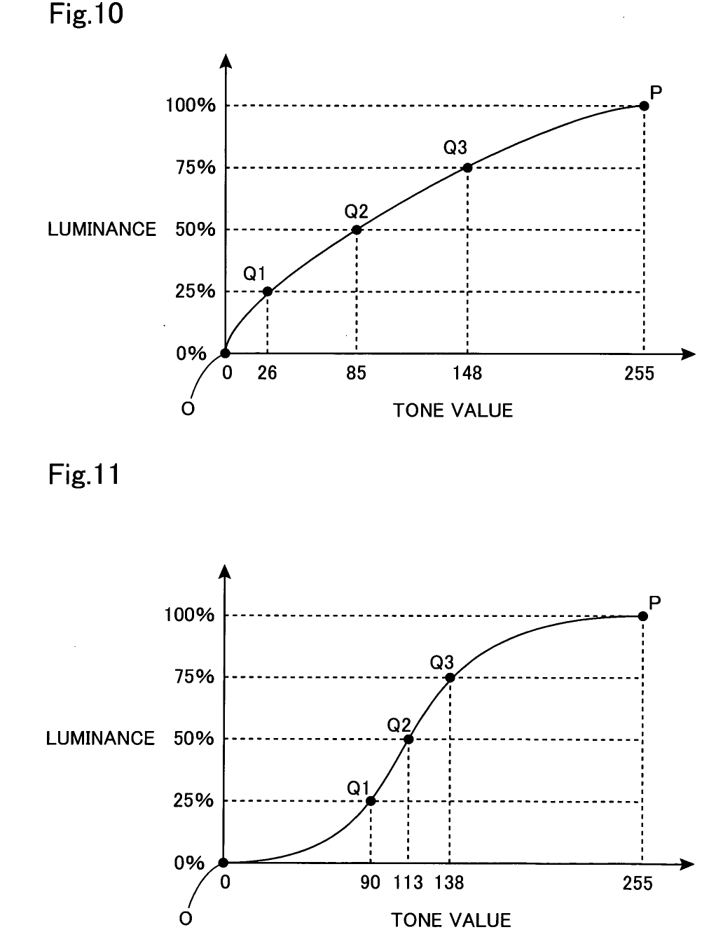

In the case where the curve of the tone reproduction characteristics cannot be approximated by a function curve having the power term, γ, it is difficult to determine an accurate approximate function curve just with the three points of O, P, and Q. An example of determining tone reproduction characteristics that are expressed by an arbitrary function by plotting more points on a graph will now be described. Specifically, an embodiment wherein three points, Q1, Q2, and Q3, are plotted besides the respective ends O and P of the graph as shown in FIG. 10 to determine an approximate function curve that passes through the five points, O, Q1, Q2, Q3, and P, by computation will now be described.

Firstly, point Q2 shown in FIG. 10 can be measured by the method that has been described above. That is, the illustrated point Q2 can be plotted from the measurement result that the corresponding tone value for a reference luminance of 50% is 85. Such measurement is performed using a test pattern, wherein a reference pattern that falsely exhibits a luminance of 50% is displayed inside second attribute region 20 as shown in FIG. 3B, and performing the tone value varying processes for making the even pattern displayed in first attribute region 10 become matched in brightness and color to the reference pattern.

Meanwhile, to determine points Q1 and Q3, the reference luminance of the reference pattern displayed in second attribute region 20 is changed to 25% and 75%, respectively, and then the measurement processes of exactly the same procedures are carried out. With the example shown in FIG. 10, point Q1 is plotted in accordance with the measurement result that the corresponding tone value for the reference luminance of 25% is 26 and point Q3 is plotted in accordance with the measurement result that the corresponding tone value for the reference luminance of 75% is 148. Obviously in actuality, the corresponding tone values corresponding to the reference luminance values of 25%, 50%, and 75% are determined for each of the primary colors, and the respective points Q1, Q2, and Q3 are plotted for each primary color.

The reference luminance of the reference pattern can be set arbitrarily by adjusting the area ratio of first sub-regions 21 and second sub-regions 22. For example, the reference pattern shown in FIG. 3B is arranged as a black-and-white stripe pattern wherein stripe-like first sub-regions 21, with the minimum tone value of 0, and second stripe-like sub-regions 22, with the maximum tone value of 255, are positioned in alternation, and since the area ratio of first sub-regions 21 to second sub-regions 22 is set to 1:1, the reference luminance is 50%. By setting this area ratio to 3:1 (for example, by setting the width of each black band to be three times that of each white band), the reference pattern with a reference luminance of 25% can be realized, and by setting this area ratio to 1:3 (for example, by setting the width of each black band to be ⅓rd that of each white band), the reference pattern with a reference luminance of 75% can be realized.

Generally, N reference patterns of mutually different reference luminance can be formed by setting a plurality (N) of area ratios for first sub-regions 21 and second sub-regions 22. By the operator performing the visual recognition measurement tasks as described above on N test patterns using such N types of reference patterns, N corresponding tone values corresponding to the respective reference luminance values are obtained. Then as shown in FIG. 10, upon defining a two-dimensional coordinate system, having the tone value as a first coordinate axis (abscissa) and the luminance as a second coordinate axis (ordinate), N points (the three points Q1, Q2, and Q3 in the case of the example of FIG. 10), having the respective reference luminance values and corresponding tone values as the coordinate values, are plotted onto this coordinate system, the point having the minimum luminance value and minimum tone value as the coordinate values (the origin O in the case of the example FIG. 10) and the point having the maximum luminance value and maximum tone value as the coordinate values (the point P in the case of the example FIG. 10) are plotted, and a curve passing through the total of (N+2) plotted points is determined as the curve indicating the tone reproduction characteristics, and such a curve indicating the tone reproduction characteristics is determined for each primary color.

Various methods are known for determining an approximate function curve that passes through such plurality of coordinate points that have been plotted onto a two-dimensional coordinate system. For example, spline curves and Bezier curves are widely known as approximate function curves that pass through a plurality of points, and if necessary, approximation using such curves is performed.

As mentioned above, in the case of a general CRT monitor, upon plotting five points O, Q1, Q2, Q3, and P as shown in FIG. 10, an approximation by a function curve defined by a power form is possible. However, measurements by the present inventor have shown that with a liquid crystal display, a sigmoid (S-shaped) characteristics curve, such as that shown in FIG. 11, is obtained in not so few cases. Though such a sigmoid characteristics curve cannot be approximated by a general gamma characteristics curve that is defined by a power form, approximation using spline curves or Bezier curves, etc., can be performed.

However for practical use, approximation using spline curves or Bezier curves, etc., is not necessarily appropriate. This is because spline curves and Bezier curves are curves for expressing contour shapes of objects used in drawing type plotting software and have properties that are not suitable for expressing curves with physical significance. Specifically, the tone value and luminance, which are variables of the function that indicates tone reproduction characteristics, are both variables that should take on positive values and do not take on negative values. The graph of FIG. 11 is thus a graph that is defined only in the first quadrant of the two-dimensional coordinate system. However, when approximation by spline curves or Bezier curves, etc., is performed, since an approximation that ignores such physical significance is carried out, the resulting curve may run over into the second quadrant or the fourth quadrant.

Appropriate considerations are thus required in determining the approximate curve.

The present inventor thus found that when for five points O, Q1, Q2, Q3, and P, plotted on the two-dimensional coordinate system, an approximation by a function curve defined by a power form is attempted and the approximation fails, it is effective to consider that the curve is a sigmoid characteristics curve, such as shown in FIG. 11, and to divide the curve into two portions by the method described below and approximate each portion by a function curve defined by a power form. Specifically, for the example shown in FIG. 11, approximation by two function curves, that is a first function curve, passing through the respective points O, Q1, and Q2, and a second function curve, passing through the respective points Q2, Q3, and P, is carried out. Here, both of the two function curves may be approximated by function curves defined by a power form. Curves that lie within the first quadrant will thus always be obtained.

This method is thus one wherein, when the five points plotted on the two-dimensional coordinate system are referred to as the first point to the fifth point in the order of increasing coordinate value along the first coordinate axis, the first function curve, which passes through the first, second, and third points and is of the form wherein the luminance is expressed as a power of the tone value, and the second function curve, which passes through the third, fourth, and fifth points and is of the form wherein the luminance is expressed as a power of the tone value, are determined by computation, and the curve formed by connecting the first function curve and the second function curve is deemed to be the curve indicating the tone reproduction characteristics. Though in such a case where two function curves are connected, there is the possibility that the curvatures of the function curves are discrepant at the third point that is to be the connection point (point Q2 in FIG. 11), this will not present a problem in particular in using the resulting curve as a curve that indicates the tone reproduction characteristics.

<<<Section 5. More Preferable Test Patterns>>>

Test patterns, which are more preferable in putting the present invention into practice, will now be described. With the embodiments described up until now, a test pattern, made up of a square first attribute region 10 and a frame-like second attribute region 20 that surrounds the periphery of the first attribute region as shown in FIG. 3A, is used, and a reference pattern that is a stripe pattern, as shown in FIG. 3B, is formed inside second attribute region 20. Though such a test pattern is a pattern that has been used conventionally, it is not necessarily an optimal test pattern.

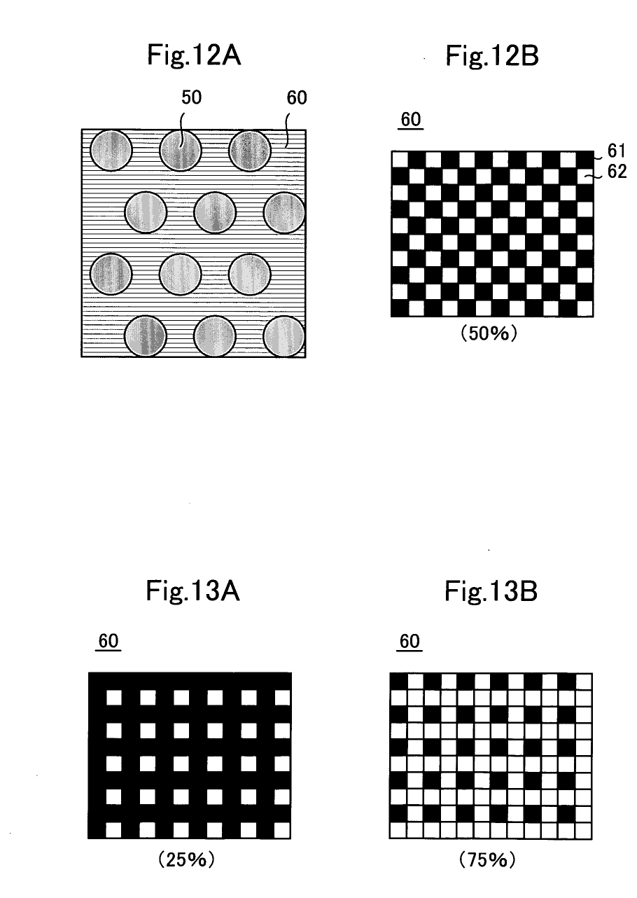

The present inventor has found that more accurate measurements are enabled by using a test pattern, such as shown in FIG. 12A, in place of the conventional test pattern shown in FIG. 3A, and using a reference pattern, such as shown in FIG. 12B, in place of the conventional reference pattern shown in FIG. 3B. Though the test pattern shown in FIG. 12A is made up of first attribute regions 50 for displaying an even pattern and a second attribute region 60 for displaying a reference pattern, as shown by the enlarged plan view of FIG. 12B, the reference pattern is a pattern of a checkerboard design formed by first sub-regions 61 (black cells in the FIGURE) and second sub-regions 62 (white cells in the FIGURE). Though in FIG. 12A, hatching by means of horizontal lines is applied inside second attribute region 60 for the sake of illustration, in actuality, a reference pattern, which is a checkerboard pattern and having a reference luminance of 50%, as shown in the enlarged plan view of FIG. 12B, is formed inside second attribute region 60. The characteristics of the test pattern shown in FIG. 12A and the reference pattern shown in FIG. 12B and the unique effects obtained by these characteristics will now be described.

(1) A Characteristic Concerning the Reference Pattern

A comparison of the reference pattern shown in FIG. 12B with the reference pattern shown in FIG. 3B shows that whereas the latter is arranged as a black-and-white stripe pattern, the former is arranged as a black-and-white checkerboard pattern. Here, the reference pattern shown in FIG. 12B is a checkerboard pattern because this reference pattern happens to be a pattern that indicates a reference luminance of 50%, and an essential point is that first sub-regions 61 (black) and second sub-regions 62 (white) are arranged as unit cells of the same shape and size and the reference pattern is arranged from a two-dimensional array of these unit cells. In particular, with the example shown here, a reference pattern is arranged by arraying rectangular (square in the present example) unit cells in the form of a two-dimensional array.

In comparison to a reference pattern formed as a stripe pattern, a reference pattern arranged from a two-dimensional array of unit cells having the same shape and size provides the effect of increasing the simulated uniformity upon observation. During visual measurement by the operator, a reference pattern will be observed from some viewing distance, and the design itself will actually not be recognized directly by the operator regardless of whether the pattern is of a stripe design or of a checkerboard design, and in both cases, the pattern will be recognized as a substantially gray, even pattern. However, since the checkerboard design pattern is formed of finer unit cells, the uniformity during observation will be improved.

This characteristic is especially significant when a reference pattern having a reference luminance besides 50% is formed. For example, in the case of the embodiment described in Section 4, reference patterns of the three reference luminance values of 25%, 50%, and 75% must be prepared, and the method of forming reference patterns from two-dimensional arrays of unit cells exhibits its effect especially in such a case. Examples in which reference patterns of a reference luminance of 25% and of 75% are formed using reference patterns in which rectangular unit cells are arrayed in two-dimensional arrays are shown in FIGS. 13A and 13B. In FIG. 13B, though the boundary lines of the respective unit cells making up second sub-regions 62 (white) are drawn for the sake of description, in actuality, these boundary lines between white cells are not displayed.

The setting of the reference luminance is accomplished by changing the area ratio of first sub-regions 61 (black) and second sub-regions 62 (white). That is, in order to set the reference luminance to 25%, the area ratio must be set to 3:1, and in order to set the reference luminance to 75%, the area ratio must be set to 1:3. When reference patterns, in which rectangular unit cells are arrayed in a two-dimensional array, are used, the area ratios of 1:1 (FIG. 12B), 3:1 (FIG. 13A), and 1:3 (FIG. 13B) can be set rationally while providing patterns with which the simulated uniformity is secured adequately.

With all of these three reference patterns, a single cell group is formed from four cells, positioned in two rows and two columns. Here, when of the four unit cells making up each cell group, first sub-regions 61 (black) are arranged from a pair of diagonally adjacent unit cells and second sub-regions 62 (white) are arranged from the remaining pair of unit cells, the reference pattern with an area ratio of 1:1, which is shown in FIG. 12B, can be arranged. Also, when of the four unit cells making up each cell group, a sub-region of one type is arranged from one unit cell and sub-regions of the other type are arranged from the remaining three unit cells to form a reference pattern with an area ratio of 3:1 or 1:3, the reference pattern shown in FIG. 13A or 13B can be arranged. In all cases, since the reference pattern that is formed will be a repeated pattern of cell groups, each made up of four unit cells positioned in two rows and two columns, the simulated uniformity can be secured adequately.

To summarize, by defining cell groups, each formed of four unit cells, which, using arbitrary odd numbers i and j, are referred to as the unit cell of the i-th row and j-th column, the cell of the i-th row and (j+1)-th column, the cell of the (i+1)-th row and j-th column, and the cell of the (i+1)-th row and (j+1)-th column, and making the pattern of positioning of the first sub-regions and second sub-regions the same for all cell groups, the reference pattern that is formed will be a repeated pattern of cell groups, each made up of four unit cells positioned in two rows and two columns that enables the simulated uniformity to be secured.

Meanwhile, in order to set the reference luminance to 25% or 75% by means of a conventional stripe type reference pattern, such as shown in FIG. 3B, an alignment of rows, such as black, black, black, white or black, white, white, white, must be formed, and lowering of the simulated uniformity thus cannot be avoided.

(2) A Characteristic Concerning the Shape of the First Attribute Region

Next, a comparison of the shape of first attribute region 10 in the test pattern shown in FIG. 3A and the shape of first attribute region 50 in the test pattern shown in FIG. 12A shows that whereas the former is a square, the latter is a circle. The present inventor considers that the boundary line between the first attribute region and the second attribute region in the test pattern should not be a straight line but should be a curve, and that for practical use, it is preferable for the contour of the first attribute region that makes up the test pattern to be a circle or an ellipse. This is because when the boundary line between the two regions is made a straight line, a regular pattern will be conspicuous near the pattern. When as shown in FIG. 3A, the shape of first attribute region 10 is made a square, a regular pattern will be visually recognized along the contour of this square shape and this will have an adverse effect on the matching judgment process. In particular, since not only the judgment of brightness matching but the judgment of color matching must also be made in this invention, elements that have an adverse effect on the matching judgment process must be eliminated as much as possible.

(3) A Characteristic of Dispersedly Positioning the First Attribute Regions in Plural Locations

A major characteristic of the test pattern shown in FIG. 12A is that first attribute regions 50 are positioned dispersedly at a plurality of locations, and second attribute region 60 is arranged as a background portion thereof. That is, whereas with the conventional test pattern shown in FIG. 3A, just one first attribute region 10, formed as a square, is positioned at the center, with the test pattern of the present invention shown in FIG. 12A, a plurality of first attribute regions 50, formed as circles, are positioned dispersedly horizontally and vertically at a prescribed pitch.

A reason for dispersedly positioning first attribute regions 50 at plural locations in this manner is to make the total length of the boundary lines between first attribute regions 50 and second attribute region 60 as long as possible. In measurements based on the basic principles of this invention, the task of comparing the brightness and color of the even pattern formed inside each first attribute region and the reference pattern displayed inside the second attribute region is essential, and this comparison task can be performed more readily the longer the boundary lines between the two types of regions. Actually in the visual confirmation task performed by the operator, matching is certified when first attribute regions 50 appear to have become dissolved inside second attribute region 60 and the boundaries between the two cannot be recognized. Thus in terms of carrying out matching recognition of higher precision, the longer the boundary lines between the two types of regions, the more preferable.

By dispersedly positioning first attribute regions 50 at plural locations, the total length of the boundary lines can be made correspondingly longer. Actually, from a comparison of the total length of the boundary lines of the test pattern shown in FIG. 3A with that of the test pattern shown in FIG. 12A, it should be readily understood that the latter is far longer. In opposition to the embodiment illustrated here, the second attribute region may be positioned dispersedly at plural locations and the first attribute region may be made the background thereof instead (by making region 60 be of the first attribute and regions 50 be of the second attribute in FIG. 12A).

For practical use, the total area of first attribute regions 50 and the total area of second attribute region 60 are preferably set equal to each other. For example, in the case of the test pattern shown in FIG. 12A, first attribute regions 50 are made up of a total of twelve circular regions and second attribute region 60 is made up of the background region in which these circular regions are positioned, and in this case, the total area of the total of twelve circular regions is preferably set to be equal to the area of the background region. This is done in consideration of making the display regions of the even patterns and the display region of the reference pattern, which are both objects of comparison, the same in area to enable comparison on an equal basis. If, in the case where the matching of both brightness and color are to be recognized as in the present invention, the area of one type of region is greater, the visual sense will be drawn to the region of larger area, and matching may be recognized erroneously even if recognition of matching is not attained in the strict sense. By making the two types of regions equal in total area, comparison on an equal basis, with which such erroneous recognition is eliminated, is made possible.

(4) A Characteristic Concerning the Positioning Pitch of the First Attribute Regions

As mentioned above, a major characteristic of the test pattern of the present invention shown in FIG. 12A is that the first attribute (or second attribute) regions are positioned dispersedly at plural locations. A characteristic concerning the pitch of this positioning will now be described.

As will be described in detail later, it is known that in cases of visually distinguishing differences in brightness and color, the human recognition sensitivity is dependent on the spatial frequency of the object. Thus an object to be visually recognized is preferably positioned at a prescribed spatial frequency for which the human recognition sensitivity is deemed to be high. Thus with the test pattern shown in FIG. 12A, all of first attribute regions 50 are preferably made regions of the same shape and size and are positioned dispersedly on a two-dimensional plane at a prescribed pitch that provides a prescribed spatial frequency for which the human recognition sensitivity is deemed to be high.

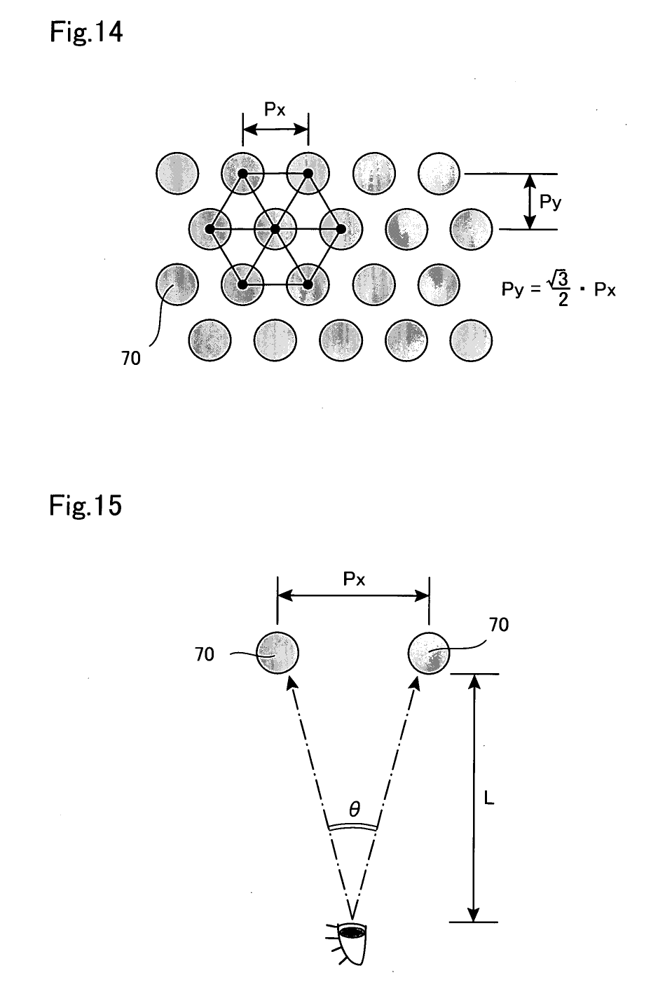

FIG. 14 is a plan view showing an example wherein first attribute regions 70 are formed of circles of the same radius r and are positioned at a prescribed pitch on a two-dimensional plane. More specifically, a plurality of one-dimensional region arrays, in each of which a plurality of first attribute regions 70 are positioned in the horizontal direction at a prescribed pitch Px, are positioned in the vertically direction at a prescribed pitch Py (where Py=(√3)/2·Px) and so that the phase is shifted by half a pitch between mutually adjacent one-dimensional region arrays. Put in another way, this two-dimensional plane is arranged to be filled by a plurality of unit regions, each of which is the hexagonal unit region that is illustrated, and the centers of seven circles are positioned at the center and at the respective apex positions of the hexagonal shape that makes up each unit region.

By such positioning, the pitch of a pair of circles that are adjacent in the horizontal direction will always be the pitch Px, the pitch of a pair of circles that are adjacent in the diagonally up or down direction will also always will be the pitch Px, and a pair of circles positioned adjacently in the two-dimensional plane will thus always be positioned at the pitch Px. Thus by setting the pitch Px to a pitch corresponding to the prescribed spatial frequency for which the human recognition sensitivity is deemed to be high, a test pattern of preferable recognition sensitivity will be obtained.

When as mentioned above, the total area of the first attribute regions, formed as circles, is set equal to the area of the second attribute region arranged as a background portion thereof, a fixed relationship holds between radius r and pitch Px. That is, the condition, that in the hexagonal region, the area of the regions inside the respective circles (the gray regions in the FIGURE) be equal to the area of the regions outside the respective circles (the white regions in the FIGURE), is imposed, and under this condition, the following approximation is derived from a geometrical area calculation:
(radius r of each circle)≈(pitch Px)×(⅜)

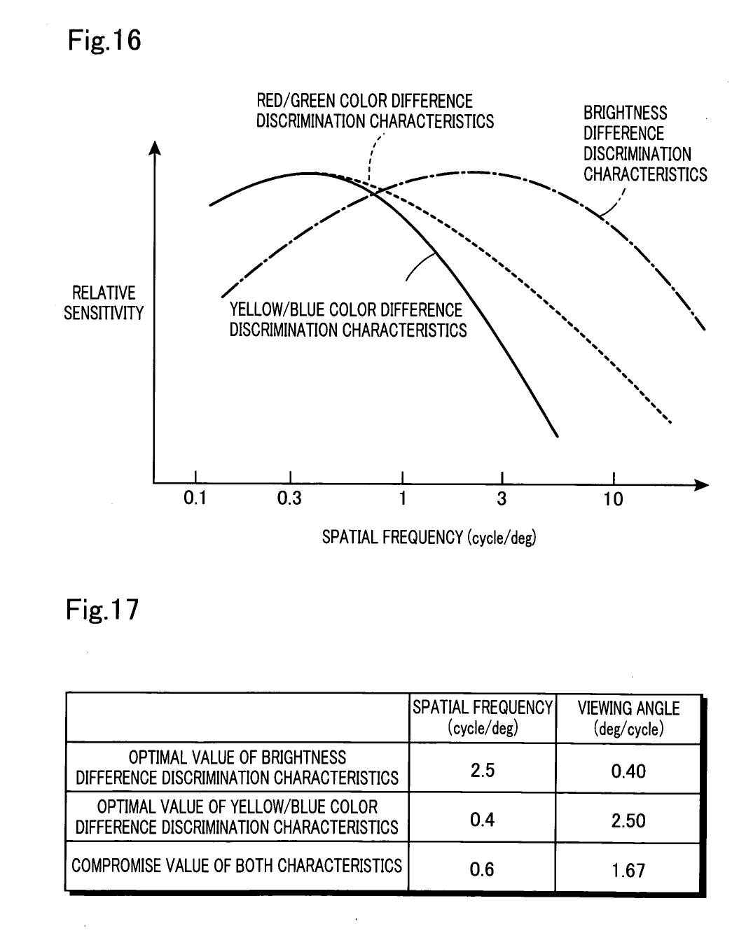

Next, consider a model wherein a pair of objects (circular first attribute regions) 70 are positioned at the pitch Px as shown in FIG. 15. Let θ be the viewing angle when this pair of objects 70 is observed from a viewing distance L. In general, the sensitivity of a vision system that is measured with sine wave and rectangular wave patterns of various frequencies that are fixed in time and displayed spatially is called a spatial frequency characteristic modulation transfer function or contrast discrimination sensitivity characteristic, and the sensitivity of the human vision system with respect to objects that are positioned repeatedly at a prescribed pitch is considered to be dependent on the viewing angle θ. For example, a graph of the sensitivity characteristics of the human vision system, such as shown in FIG. 16, is shown in “Haruo Sakata and Haruo Isono: Spatial frequency characteristics of chromaticity (color difference discrimination threshold) in color perception, Journal of Television Science, 1977, Vol. 31(1), pp. 29-35.” Here, the abscissa indicates the spatial frequency (unit: cycle/deg) of the observed object in logarithmic scale, and the ordinate indicates the relative sensitivity value of the human vision system of discriminating brightness differences and color differences in an object.

In consideration of the characteristics such as shown in FIG. 16, in a point of view of the operator viewing the test pattern, measurement results of higher precision can be anticipated, if regions of the same attribute are dispersedly positioned to arrange the test pattern at a prescribed pitch so as to obtain a spatial frequency in which good sensitivity is exhibited for both brightness difference discrimination characteristics and color difference discrimination characteristics.

The table shown in FIG. 17 is obtained by extraction of the respective optimal values from the graph of FIG. 16. That is, from the graph of FIG. 16, the optimal value for the brightness difference discrimination characteristics (the spatial frequency corresponding to the peak of the curve indicated by the alternate long and short dash line) is determined as 2.5 [cycle/deg], and the optimal value for the yellow/blue color difference discrimination characteristics (the spatial frequency corresponding to the peak of the curve indicated by the solid line) is determined as 0.4 [cycle/deg]. Also, as a compromise value of the two characteristics, a value, for example, of approximately 0.6 [cycle/deg] can be set. Actually according to the graph shown in FIG. 16, some degree of sensitivity is obtained for both characteristics at a spatial frequency of approximately 0.6, and by forming a test pattern with which the spatial frequency is set to the compromise value of 0.6, fairly good recognition sensitivity will be provided for performing brightness matching recognition and color matching recognition.

The spatial frequency (unit: cycle/deg) and the viewing angle (unit: deg/cycle) are in an inverse relationship, and the viewing angles corresponding to the respective spatial frequencies, 2.5, 0.4, and 0.6 in the table of FIG. 17 are 0.40, 2.50, and 1.67, respectively. This means that by positioning first attribute regions 70 at a pitch Px such that the viewing angle θ shown in FIG. 15 will be 0.40 deg, 2.50 deg, or 1.67 deg, a pattern of optimal brightness difference discrimination characteristics, a pattern of optimal yellow/blue color difference discrimination characteristics, or a pattern that is a compromise for both characteristics will be obtained.

Since the viewing angle θ and the pitch Px are related to each other via the viewing distance L by:
Px=2L·tan(θ/2)

even if the viewing angle θ is set, unless the viewing distance L is determined, the pitch Px cannot be determined. However, in the case of a general monitor, the viewing distance of the operator will be maintained within a substantially fixed range. For example, according to the VDT Working Guidelines of the National Personnel Authority of Japan issued on Dec. 16, 2002, it is deemed that a viewing distance of no less than 40 cm must be secured, and in an actual working environment, though there may be slight differences depending on the size of the monitor, etc., it can be considered that viewing distance is substantially approximately 40 cm. Thus for practical use, the viewing distance L is set to approximately 40 cm and a pitch Px, with which fairly good recognition sensitivity can be obtained for both the brightness difference discrimination characteristics and the color difference discrimination characteristics, is set accordingly.

For example, when the viewing distance L is set to 40 cm, the pitch corresponding to the viewing angle θ of 1.67 deg, which is the compromise value shown in FIG. 17 for both characteristics, will be calculated by the above equation as Px≈12 mm. Thus in the case of the test pattern shown in FIG. 14, the setting, Px≈12 mm, is made. Also, in order to make the total area of the first attribute regions that are formed as circles be equal to the area of the second attribute region arranged as a background portion thereof, the radius of each circle is calculated by the above equation, 37 r≈Px·⅜,” so that r≈4.5 mm. Thus in the case of a monitor, wherein the size of a single pixel is 0.25 mm, a test pattern, wherein the radius of each circle is set to 18 pixels and the pitch Px is set to 48 pixels, is displayed.

More strictly speaking, since as is indicated in the table of FIG. 17, the optimal value for brightness difference discrimination characteristics and the optimal value for color difference discrimination characteristics differ, in a more preferable embodiment, a first pitch, enabling the obtaining of a spatial frequency that indicates good sensitivity concerning brightness difference discrimination characteristics for the operator who views the test pattern, and a second pitch, enabling the obtaining of a spatial frequency that indicates good sensitivity concerning color difference discrimination characteristics, are set respectively, and a process of switching the arrangement of the test pattern to be displayed is performed so that a test pattern, in which regions of the same attribute are positioned dispersedly at the first pitch, is displayed when the brightness matching recognition work is performed by the operator, and a test pattern, in which regions of the same attribute are positioned dispersedly at the second pitch, is displayed when the color matching recognition work is performed by the operator.

For example, with the table of FIG. 17, when the viewing distance L is set to 40 cm, the pitch and circle radius corresponding to a viewing angle θ of 0.40 deg, which is the optimal value for the brightness difference discrimination characteristics will be such that the pitch Px≈2.8 mm and the radius r≈1.1 mm. Meanwhile, the pitch and circle radius corresponding to a viewing angle θ of 2.50 deg, which is the optimal value for the yellow/blue color difference discrimination characteristics will be such that the pitch Px≈17.5 mm and the radius r≈6.6 mm. Thus in the case of performing the processes based on the flowchart shown in FIG. 9, a test pattern, with which circles are positioned so that the pitch Px≈2.8 mm and the radius r≈1.1 mm, is displayed when performing the “brightness matching” recognition process of steps S2 and S3, and a test pattern, with which circles are positioned so that the pitch Px≈17.5 mm and the radius r≈6.6 mm, is displayed when performing the “color matching” recognition process of steps S4 and S5.

The task of carrying out brightness or color matching recognition using a test pattern in which a plurality of circles of the above-mentioned sizes are positioned will actually be felt by the operator not to be a “task of matching the brightness and color of the two types of regions” but to be a “task of adjusting so that there will be no non-uniformity of brightness and color in the test pattern as a whole.” That is, if the brightness and color are not matched, it will be felt as if there is a non-uniformity of brightness or color at the cycle of the pitch Px. Visual measurements using the conventional test pattern shown in FIG. 3A and visual measurements using this invention's test pattern shown in FIG. 12A will thus differ greatly in terms of the sensation of the operator, and measurements using the test pattern of this invention will enable better results to be obtained.

<<<Section 6. Arrangement of a Tone Reproduction Characteristics Measuring Device by this Invention>>>

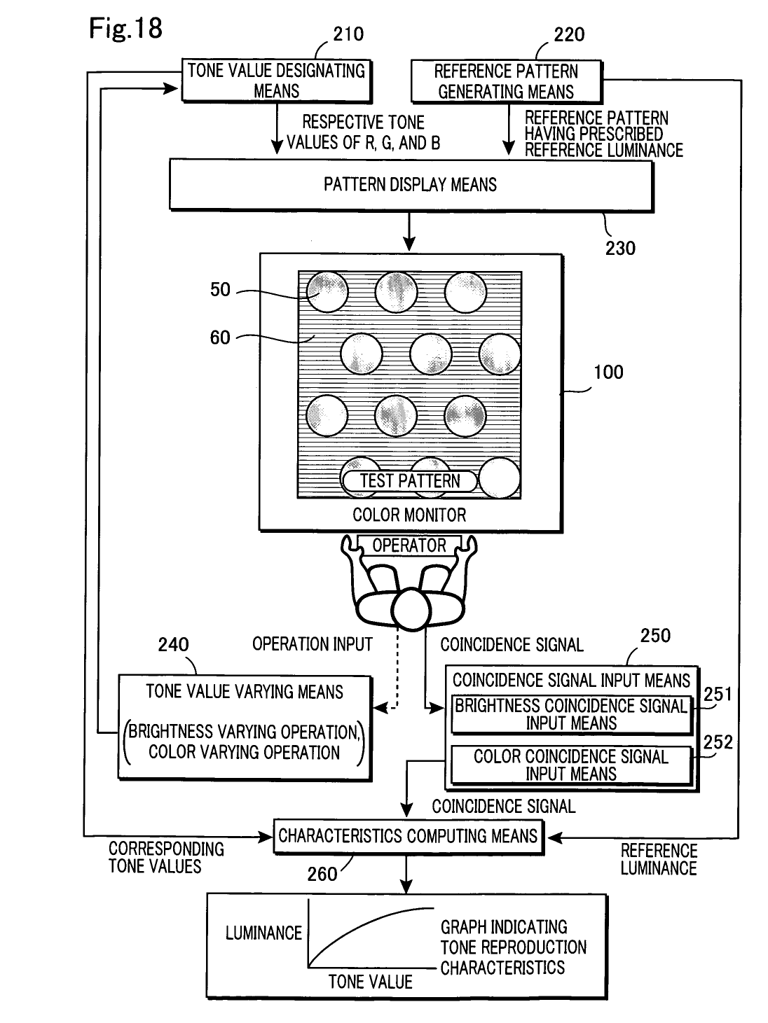

The basic arrangement of a tone reproduction characteristics measuring device for color monitor by this invention will now be described with reference to the block diagram of FIG. 18. As illustrated, the tone reproduction characteristics measuring device for color monitor according to the present invention has a tone value designating means 210, a reference pattern producing means 220, a pattern display means 230, a tone value varying means 240, a coincidence signal input means 250, and a characteristics computing means 260 as the main components and has a function of measuring the tone reproduction characteristics of color monitor 100 by means of visual measurement operations performed by the operator.

Since the measuring device of the invention can actually be realized by installing a prescribed program in personal computer 200 connected to color monitor 100 as shown in FIG. 1, the above components are actually realized by the program installed in personal computer 200.

Tone value designating means 210 has a function of designating combinations of the tone values of the three primary colors, R, G, and B, for displaying the even pattern of uniform brightness and color inside first attribute region 50 and designates the respective tone values of R, G, and B to pattern display means 230. Meanwhile, reference pattern producing means 220 has a function of generating a reference pattern having a prescribed reference luminance by making first sub-regions, wherein the three primary colors, R, G, and B, respectively take on the minimum tone values, and second sub-regions, wherein the three primary colors, R, G, and B, respectively take on the maximum tone values, exist in mixed manner at a prescribed area ratio inside second attribute region 60. In the case of the embodiment described in Section 5, the three types of reference pattern, shown in FIGS. 12B, 13A, and 13B, can be generated selectively in accordance with the reference luminance required for measurement.

Based on the data provided from these components, pattern display means 230 displays a test pattern, such as that illustrated, on the screen of color monitor 100. This pattern is a pattern made up of first attribute regions 50 and second attribute region 60 which are positioned to contact each other, and in particular, the test pattern shown here is the same as the test pattern shown in FIG. 12A. That is, first attribute regions 50 of circular shape are positioned at a prescribed pitch on a two-dimensional plane, and second attribute region 60 is made up of the background portion. As mentioned above, the even patterns, based on the combinations of the tone values of R, G, and B that were designated by tone value designating means 210, are displayed inside first attribute regions 50, and the reference pattern, produced by reference pattern producing means 220, is displayed inside second attribute region 60. In actuality, prescribed electrical signals for making such a test pattern be displayed is provided from pattern display means 230 to color monitor 100.

Tone value varying means 240 has a function of executing the varying operation of varying the respective tone values designated by tone value designating means 210. By this varying operation, the brightness and color of the even pattern displayed inside first attribute region 50 are changed. As mentioned in Section 2, the operations of varying the tone values include the brightness varying operation and the color varying operation. With the embodiment described in Section 2, tone value varying means 240 performs the brightness varying operation and the color varying operation in accordance with operation inputs from the operator. In this case, tone value varying means 240 makes an operation panel, such as shown in FIG. 6 or 7, be displayed on the screen of color monitor 100 (normally to a side of the test pattern) and performs the process of varying the respective tone values designated by the tone value designating means 210 so that the brightness and color change based on mouse operations, etc., performed by the operator. Meanwhile, in the case of the embodiment in which the varying operations are executed automatically as described in Section 3, the brightness varying operation and the color varying operation are executed according to the procedures based on the flowchart of FIG. 9 and without waiting for operation inputs form the operator.

Coincidence signal input means 250, in the state where varying operation is performed by tone value varying means 240, has a function of inputting the coincidence signal, indicating the recognition that first attribute regions 50 and second attribute region 60 have become matched both in brightness and color, from the operator viewing the test pattern displayed on the screen of color monitor 100. In the case of an embodiment wherein the matching of brightness and the matching of color are input separately of each other, coincidence signal input means 250 comprises a brightness coincidence signal input means 251 and a color coincidence signal input means 252. For example, match button 30, shown in FIGS. 6 and 7 is a button that indicates the matching of both brightness and color, and by the operation of clicking this match button 30, the input of the coincidence signal that indicates the matching of both brightness and color is performed. Meanwhile, brightness match button 41, shown in FIG. 8, functions as brightness coincidence signal input means 251 that indicates the matching of brightness, and color match button 42, shown in FIG. 8, functions as color coincidence signal input means 252 that indicates the matching of color.

Characteristics computing means 260 recognizes the combinations of the respective tone values of R, G, and B, which are designated by tone value designating means 210 at the point at which the coincidence signal indicating the matching of both brightness and color is input from coincidence signal input means 250, to be the corresponding tone values of the respective primary colors that correspond to the reference luminance value that is in accordance with the area ratio of the first sub-regions and the second sub-regions that make up the reference pattern generated by reference pattern generating means 220, and based on the reference luminance value and the corresponding tone values that correspond to each other, executes a process of determining, by computation, curves that indicate the tone reproduction characteristics according to the respective primary colors. The specific computation methods are as have been described above. A graph that indicates the tone reproduction characteristics according to the respective primary colors, R, G, and B is thus output. Though for the sake of description, the tone reproduction characteristics are shown in the form of a graph that shows continuous functional relationships, the tone reproduction characteristics determined by characteristics computing means 260 do not need take on the form of a graph and may instead take on the form, for example, of a numerical table that indicates the correspondence between the tone values and luminance values.

Thus by the above-described tone reproduction characteristics measuring device for color monitor, tone reproduction characteristics can be determined by visual recognition at high precision.

<<<Section 7. Method for Measuring Tone Reproduction Characteristics Using a Sample Image>>>

A method for measuring tone reproduction characteristics by an approach that differs from that of the embodiments described above will now be described. The measuring method to be described in this Section 7 is based on the basic principle of visually comparing a sample image output on a physical medium, such as paper, and a sample image displayed on a monitor, and modifying provisional tone reproduction characteristics based on the comparison result to determine formal tone reproduction characteristics.

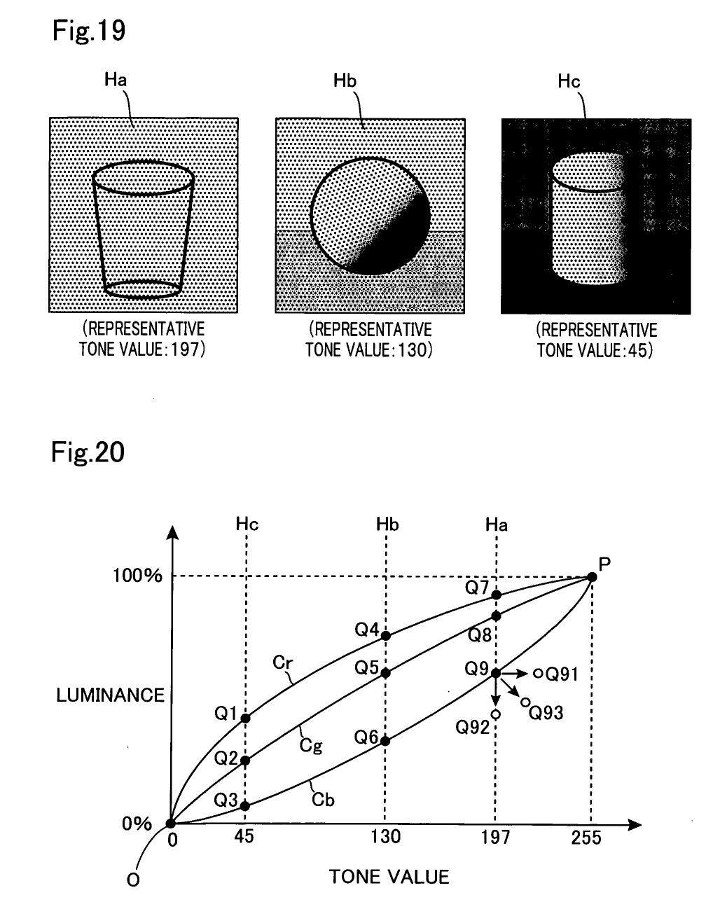

Here, an example of making a measurement using three sample images, Ha, Hb, and Hc, such as shown in FIG. 19, will be described. Though in the illustrated example, sample image Ha is a picture of a glass, sample image Hb is a picture of a sphere, and sample image Hc is a picture of a cylinder, the contents of the picture may be anything. However, the individual sample images are pictures that differ from each other in overall brightness. That is, sample image Ha is a picture that is bright overall, sample image Hb is a picture of intermediate brightness overall, and sample image Hc is a picture that is dark overall. One characteristic of this embodiment is that a plurality of sample images that differ from each other in overall brightness are prepared. Though the number of sample images prepared is 3 in the example of FIG. 19, a larger number of sample images may be prepared.

The sample images Ha, Hb, and Hc shown in FIG. 19 are actually prepared in the form of image data. To be more specific, each sample image is formed of a set of plurality of pixels, and for example in the case of an 8-bit color image, pixel values in the range of 0 to 255 are defined for each of the three primary colors, R, G, and B in each individual pixel. Moreover, since as mentioned above, sample image Ha is a picture that is bright overall, the pixel values of the majority of pixels thereof are comparatively large, since sample image Hb is a picture of intermediate brightness overall, the pixel values of the majority of pixels thereof are of substantially intermediate values, and since sample image Hc is a picture that is dark overall, the pixel values of the majority of pixels thereof are comparatively small.

Here, the mode value or the average value of the pixel values of all colors of the individual pixels making up a single sample image will be defined as the representative tone value of the sample image. To be specific, suppose the representative tone value of sample image Ha shown in FIG. 19 is 197, the representative tone value of sample image Hb is 130, and representative tone value of sample image Hc is 45 here. When a plurality of sample images that differ from each other in overall brightness are prepared, the representative tone values of the respective sample images will be distributed discretely within the range of 0 to 255.

Three curves Cr, Cg, and Cb, such as shown in FIG. 20, are then prepared as curves indicating tone reproduction characteristics (gamma characteristics). These three curves Cr, Cg, and Cb indicate relationships between the input signal tone values and the actually displayed luminance for the three primary colors, R, G, and B, respectively and, as mentioned above, are generally called “gamma curves.” An object of the measuring device of the present invention is to determine unique gamma curves for each individual color monitor, and in the case of the measuring device of the above-described embodiment shown in FIG. 18, curves, indicating the tone reproduction characteristics that are sought for, in other words, gamma curves are output from characteristics computing means 260.

By installing the gamma curves unique to each individual monitor as profile data for the monitors, corrections based on these profile data are enabled and universal display results that are not affected by the unique tone reproduction characteristics of the individual monitors can be obtained.

The basic concept of the embodiment described in this Section 7 is to provide arbitrary gamma curves as provisional tone reproduction characteristics to a personal computer, make sample images be displayed on the monitor screen upon carrying out corrections based on these gamma curves, and then performing operations of modifying the gamma curves so that the brightness and colors of the sample images displayed on the monitor approach the brightness and colors of sample images output on a physical medium and thereby modify the provisional tone reproduction characteristics to formal tone reproduction characteristics.

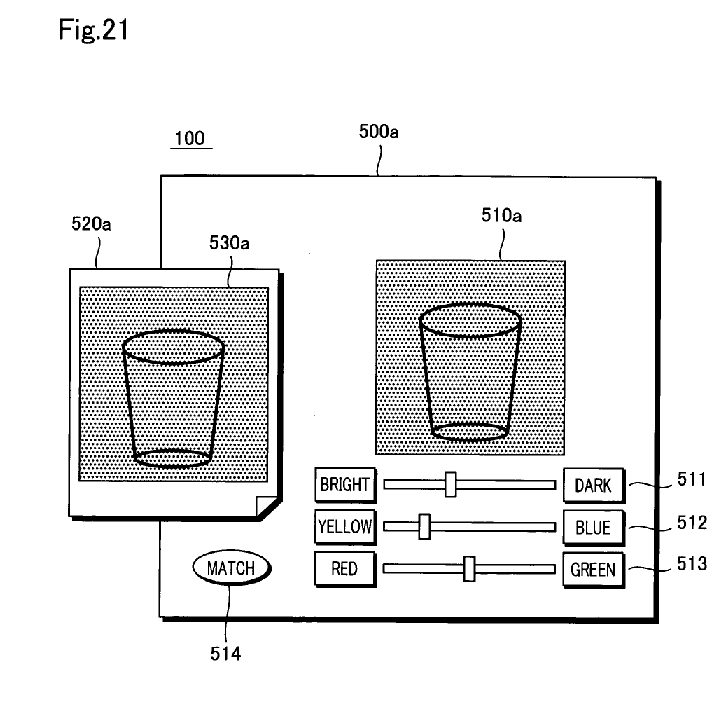

For example, the modifying operation using sample image Ha, shown in FIG. 19, can be performed as follows. First, arbitrary gamma curves Cr, Cg, and Cb, such as shown in FIG. 20, are prepared as the provisional tone reproduction characteristics. This sample image Ha is then displayed on color monitor 100. A state wherein the sample image Ha is displayed on color monitor 100 is shown in FIG. 21. That is, sample image 510a, which is shown in the FIGURE, is the sample image Ha that is displayed on a display screen 500a of the monitor.

Meanwhile, a physical output medium 520a is a medium that is obtained by outputting the sample image Ha on paper or other physical medium, and sample image 530a is an image that is fixed on this physical medium. Generally, physical output medium 520a can be obtained by providing image data, corresponding to the sample image Ha, to a color printer and printing the image onto a paper surface. However, in the case of the above example, since the sample image Ha is arranged from image data expressed in the RGB system, conversion of the image data to the CMY system is carried out in the process of printing by the color printer.

As shown in FIG. 21, the operator can visually compare sample image 510a, which is displayed on display screen 500a of the monitor, and sample image 530a, which has been printed out on physical output medium 520a. Though both are images displayed based on the image data of the original sample image Ha, whereas sample image 510a is an image obtained by applying corrections based on provisional tone reproduction characteristics, such as shown in FIG. 20, on the image data of the original sample image Ha, sample image 530a is an image obtained on a paper surface upon applying the data conversion from the RGB system to the CMY system on the image data of the original sample image Ha.

At a lower right portion of display screen 500a shown in FIG. 21 are displayed three slide bars 511 to 513. These slide bars 511 to 513 function as operation means for providing instruction inputs for adjusting the brightness and color of sample image 510a. The operator inputs instructions for adjusting the brightness and color of sample image 510a by operating these slide bars 511 to 513 and thereby performs the adjusting operation of matching the brightness and color to those of sample image 530a.

Slide bar 511 has a function of adjusting the brightness of sample image 510a, and by moving its knob to the left using a mouse, the image can be made brighter, and by moving the knob to the right, the image can be made darker. Adjustment of the brightness can also be performed by clicking the buttons provided at the respective ends of the bar. For example, when the “Bright” button is clicked, the knob moves by just a prescribed amount to the left, and when the “Dark” button is clicked, the knob moves by just a prescribed amount to the right.

Slide bar 512 has a function of adjusting a first tint (yellow/blue) of sample image 510a, and by moving its knob to the left using the mouse, the yellow component of the colors of the image can be made stronger, and by moving the knob to the right, the blue component of the colors of the image can be made stronger. Since yellow and blue are in a complementary relationship, when one is made stronger, the other is made weaker. Adjustment of the first tint can also be performed by clicking the buttons provided at the respective ends of the bar. For example, when the “Yellow” button is clicked, the knob moves by just a prescribed amount to the left, and when the “Blue” button is clicked, the knob moves by just a prescribed amount to the right.

Slide bar 513 has a function of adjusting a second tint (red/green) of sample image 510a, and by moving its knob to the left using the mouse, the red component of the colors of the image can be made stronger, and by moving the knob to the right, the green component of the colors of the image can be made stronger. Since red and green are in a complementary relationship, when one is made stronger, the other is made weaker. Adjustment of the second tint can also be performed by clicking the buttons provided at the respective ends of the bar. For example, when the “Red” button is clicked, the knob moves by just a prescribed amount to the left, and when the “Green” button is clicked, the knob moves by just a prescribed amount to the right.

Here, the brightness and colors of sample image 510a are changed by the adjustment operations using the respective slide bars 511 to 513 not because modifications are made directly on the image data of the original sample image Ha but because modifications are made on the gamma curves Cr, Cg, and Cb that indicate the provisional tone reproduction characteristics as shown in FIG. 20. Moreover, in the case of the embodiment illustrated here, modifications stressed on “portions corresponding to the brightness of sample image Ha” are performed.

The principles of this modification process will now be described more specifically using the gamma curves Cr, Cg, and Cb shown in FIG. 20 as examples. As mentioned above, sample image Ha is a comparatively bright picture and the representative tone value takes on a comparatively large value of 197. Thus in the adjustment operation using this sample image Ha, modifications stressed on portions of the gamma curves Cr, Cg, and Cb corresponding to comparatively high brightness are made. Specifically, on the respective gamma curves Cr, Cg, and Cb, shown in FIG. 20, points Q7, Q8, and Q9, which take on the representative tone value of 197 of sample image Ha, are recognized as control points on the respective gamma curves, and after moving these control points in prescribed directions in accordance with instruction inputs (operation inputs concerning slide bars 511, 512, and 513) by the operator, modifications are made by smoothly deforming the gamma curves so that the curves pass through the control points after movement.

Which of the three gamma curves Cr, Cg, and Cb shown in FIG. 20 should be subject to the modification and in which direction and how much the control point should be moved are determined in accordance with the instruction inputs of the operator. For example, consider the modification to be made in the case where slide bar 512, shown in FIG. 21, is slid to the right and an instruction input in the direction of “weakening yellow” is provided. In this case, the color subject to modification is blue. This is because yellow is the complement of blue and “weakening yellow” is equivalent “strengthening blue.” The gamma curve Cb for blue will thus be the curve subject to modification and the point Q9, which takes on the representative tone value of 197 on this curve Cb, will be the control point subject to movement.

Here, since the operator's instruction input indicates modification in the direction of “strengthening blue,” the control point Q9 is moved to the position of a point Q91 to the right, or moved to the position of a point Q92 below, or moved to the position of a point Q93 positioned diagonally to the lower right, and the gamma curve Cb is then modified smoothly so as to pass through the control point after this movement. When modification is made by moving the control point Q9 to any of the points Q91, Q92, and Q93, the luminance values close to the tone value of 197 of the gamma curve Cb after modification will decrease. As a result, the luminance of blue in sample image 510a, which is displayed on the monitor, will increase and blue will be strengthened. This is because, due to the lowering of the luminance values close to the tone value of 197 of the gamma curve Cb, which was provided as the provisional tone reproduction characteristics concerning blue, a correction of displaying blue more strongly is performed in order to perform color expression correctly on monitor 100 with such a gamma curve Cb.

In other words, that the operator provides an input, which instructs modification in the direction of “strengthening blue,” means that the luminance values of the monitor's true gamma curve Cb for blue are lower than the luminance values of the current provisional gamma curve Cb shown in FIG. 20. That is, since the luminance values of the true gamma curve Cb for blue are lower than the luminance values of the provisional gamma curve, the blue of the sample image Ha that was displayed on the monitor was weak in blue and the operator thus provided an instruction input in the direction of “strengthening blue.” Thus in this case, a modification of lowering the luminance values of the current provisional gamma curve Cb shown in FIG. 20 in the direction of approaching the true gamma curve Cb should be performed, and this can be done by moving, as mentioned above, the control point Q9 to the position of the point Q91 to the right, or to the position of the point Q92 below, or to the position of the point Q93 positioned diagonally to the lower right, and then smoothly modifying the gamma curve Cb so that it passes through the control point after this movement. The movement amount of the control point Q9 is determined in accordance with the amount of sliding of slide bar 512.

Needless to say, since the modification of the gamma curve Cb is performed so that the curve will be smooth as a whole, the positions of the other illustrated points Q6 and Q3 will also be modified slightly. However, the modification will mainly be stressed on the vicinity of the tone value of 197. Since various methods are known for modifying the entirety of a curve upon moving a specific control point defined on a smooth curve, a detailed description of such a method will be omitted here.

In a case where the operator slides slide bar 512 to the left and thereby provides an instruction input in the direction of “strengthening yellow (weakening blue),” modification is performed by moving the control point Q9 to the left, upwards, or diagonally to the upper left. Also, in the case where an adjustment of sliding slide bar 513 is performed, since red and green will be the subject of modification, the control point Q7 or the control point Q8 is moved to perform modification of the gamma curve Cr or the gamma curve Cg. Since red and green are in a mutually complementary relationship, no matter in which direction slide bar 513 is slid, the modification can be made by modifying just the gamma curve Cr, or by modifying just the gamma curve Cg, or by modifying both curves.

Meanwhile, in a case where the operator slides slide bar 511 to provide an instruction input of adjusting the brightness, equivalent modifications are made on all three gamma curves Cr, Cg, and Cb. For example, when slide bar 511 is slid to the left to provide an instruction input in the direction of “increasing the brightness,” all of the control points Q7, Q8, and Q9 are moved to the right, downwards, or diagonally to the lower right and all gamma curves Cr, Cg, and Cb are modified accordingly. Since the luminance values of the gamma curves that indicated the provisional tone reproduction characteristics will then be lowered, corrections in the direction of increasing the luminance will be performed in order to perform display correctly and consequently, the display luminance will increase.

Though obviously in actuality, when a color adjustment is made using slide bar 512 or 513, the brightness will change slightly as well, and oppositely when a brightness adjustment using slide bar 511 is made, the color will change slightly as well, as the brightness adjustment and color adjustment are repeated, the brightness and color of sample image 510a on the monitor will gradually approach the brightness and color of sample image 530a on physical output medium 520a. And at the stage at which the operator recognizes that both are matched in brightness and color, he/she clicks match button 514. With the present embodiment, the gamma curves Cr, Cg, and Cb, at the point at which this match button is clicked (actually, at the point at which all match buttons 514 shown in FIGS. 21 to 23 have been clicked), are output as curves indicating the formal tone reproduction characteristics.

Consequently, by performing adjustment by the above-described procedure, since modifications that are in accordance with the operator's instruction inputs are applied to the arbitrary gamma curves Cr, Cg, and Cb that were provided at the initial stage as provisional tone reproduction characteristics, the modified gamma curves Cr, Cg, and Cb at the point at which match button 514 is pressed will indicate preferable tone reproduction characteristics from the standpoint of matching the brightness and color when sample images 510a and 530a are viewed.

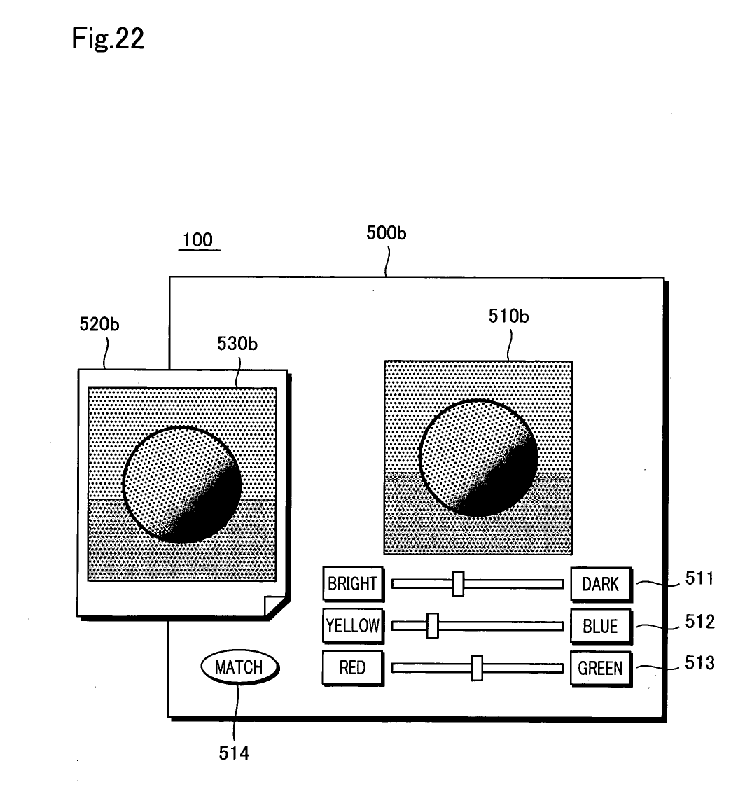

When the modification tasks using sample image Ha are thus completed, modification tasks using sample image Hb are performed subsequently in the same manner. The provisional tone reproduction characteristics that are provided at the initial stage of the modification tasks are the gamma curves Cr, Cg, and Cb that were obtained at the point of completion of the modification tasks performed using sample image Ha. FIG. 22 is a plan view showing the screen for the modification operation using sample image Hb. A sample image 510b is displayed on a display screen 500b, and modification operations using slide bars 511, 512, and 513 are performed by comparison with a sample image 530b that has been printed out on a physical output medium 520b. Since the representative tone value of sample image Hb is 130, with the modification operations here, points Q4, Q5, and Q6 on the gamma curves Cr, Cg, and Cb, shown in FIG. 20, are used as control points to modify the respective curves by the method of moving these control points and modifications stressed on portions of intermediate brightness are carried out.

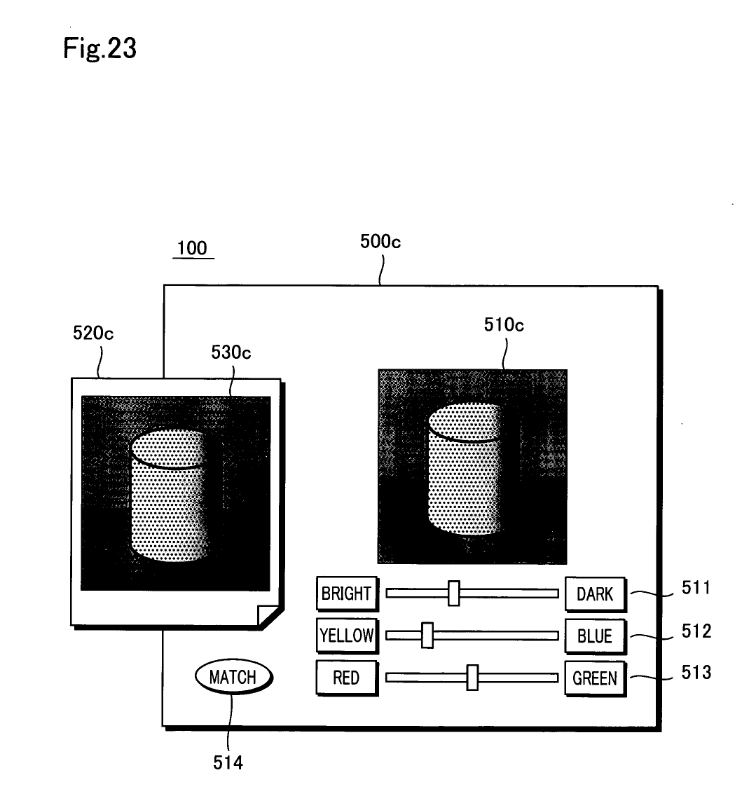

Lastly, modification tasks using sample image Hc are performed in the same manner. The provisional tone reproduction characteristics that are provided at the initial stage of the modification tasks are the gamma curves Cr, Cg, and Cb that were obtained at the point of completion of the modification tasks performed using sample image Hb. FIG. 23 is a plan view showing the screen for the modification operation using sample image Hc. A sample image 510c is displayed on a display screen 500c, and modification operations using slide bars 511, 512, and 513 are performed by comparison with a sample image 530c that has been printed out on a physical output medium 520c. Since the representative tone value of sample image Hc is 45, with the modification operations here, points Q1, Q2, and Q3 on the gamma curves Cr, Cg, and Cb, shown in FIG. 20, are used as control points to modify the respective curves by the method of moving these control points and modifications stressed on dark portions are carried out.

When all of the modification operations using the three sample images Ha, Hb, and Hc have been completed, the tone reproduction characteristics measurement tasks concerning color monitor 100 is completed. Thus in regard to Cr, Cg, and Cb shown in FIG. 20, modification using the bright sample image Ha is performed in regard to characteristics in the vicinity of a tone value of 197, modification using sample image Hb of intermediate brightness is performed in regard to characteristics in the vicinity of a tone value of 130, and modification using the dark sample image Hc is performed in regard to characteristics in the vicinity of a tone value of 45, and modification using respectively appropriate sample images for different portions of the gamma curves is thus completed.

Needless to say in actuality, there is a high likelihood that when, after performing the modification operations using the three sample images Ha, Hb, and Hc in that order, visual comparison of sample image Ha is carried out again, the state of matching of brightness and color is found to have become disrupted. This is because, though, due to the movement of a control point, the modification of a gamma curve is stressed on the vicinity of the corresponding control point, this modification affects the entirety of the gamma curve. Thus for practical use, the modification operations using the three sample images Ha, Hb, and Hc are preferably repeated a plurality of times in a cyclic manner if necessary.

When, in the final stage, the operator recognizes that, for all of the three sample images, the brightness and color of the images displayed on the monitor match the brightness and color of the images output on the physical output medium, the gamma curves Cr, Cg, and Cb at that point are output as curves indicating the formal tone reproduction characteristics concerning color monitor 100. Needless to say, it is extremely difficult to make the brightness and color of images displayed on a monitor be matched completely with those of images output on a physical output medium in a strict sense. First of all, unless the white on color monitor 100 is completely matched with the white on the physical output medium, it is impossible to perform an adjustment of making the two images be matched strictly in terms of brightness and color. Thus with the present embodiment, “matching of brightness and color” signifies that the degree of closeness of these aspects have reached a state where matching can be recognized under the sensory judgment based on visual recognition by the operator.

The gamma curves, Cr, Cg, and Cb, which are output as the formal tone reproduction characteristics by the above-described method for measuring tone reproduction characteristics using sample images do not indicate monitor characteristics that are based on absolute standards but only indicate relative characteristics based on the sample images. For example, even if measurements using the image data of the same sample image Ha are performed on the same color monitors, if different printers or different papers are used in preparing the physical output medium, the gamma curves that are output as the formal tone reproduction characteristics will differ. This is because, as with monitors, printers also have respectively unique tone reproduction characteristics, and output media that are printed using the same image data will differ in brightness and color if different printers are used.

Thus in order to determine tone reproduction characteristics that are based on the absolute standard for each individual color monitor by the method described here, the brightness and color of the sample images used must be measured physically and some form of correction based on the measurement results must be applied. However, for use in a practical application of modifying the scattering of tone reproduction characteristics among a plurality of color monitors used in DTP processes, there is no need to determine tone reproduction characteristics based on the absolute standard. For example, consider an application in an environment where DTP processes are to be executed by division of labor among a staff of 50 and the tone reproduction characteristics of each of 50 color monitors are to be measured in order to correct the scattering of the tone reproduction characteristics among the respective color monitors. In this case, 50 sheets of the physical output media are prepared by printing out the same sample images on paper of the same quality using the same printer. Since the sample images that are printed out on the 50 physical output media are the same in brightness and color, when the tone reproduction characteristics of the 50 color monitors are respectively measured using these 50 physical output media, the measurement results that are obtained will all be based on the same standards and the intended purpose will thus be achieved. Needless to say, a single physical output medium may be shared for measurement of the tone reproduction characteristics of the 50 color monitors.

Though as the sample images, images of any picture may be used, in order to facilitate the visual comparison work performed by the operator, it is preferable to use images that can be recognized as being achromatic pictures when viewed by the operator. Though obviously the actual images that are displayed on the monitor are images that are displayed as mixtures of the three primary colors, R, G, and B, by using images that can be recognized, when observed by the naked eye, as pictures that are expressed in shades of gray (images, for which the tone values of the three primary colors R, G, and B of a single pixel are substantially the same), the judgment of color matching can be performed especially readily. This is because the sensitivity of perception of color components by human eyes is highest in the vicinity of the achromatic state.

For example, if a bright red color is used as a base and the redness is strengthened slightly or the redness is weakened slightly, such a delicate change of color cannot be sensed readily by the naked eye. However, if an achromatic color is used as a base and the redness is strengthened slightly or the redness is weakened slightly (actually, the complementary color of green is strengthened slightly), such a change of color can be sensed by the naked eye even if the change is delicate. When an achromatic color is used as a base, a lightly reddish state or a lightly greenish state can be sensed readily by the naked eye.

<<<Section 8. Tone Reproduction Characteristics Measuring Device That Uses Sample Images>>>

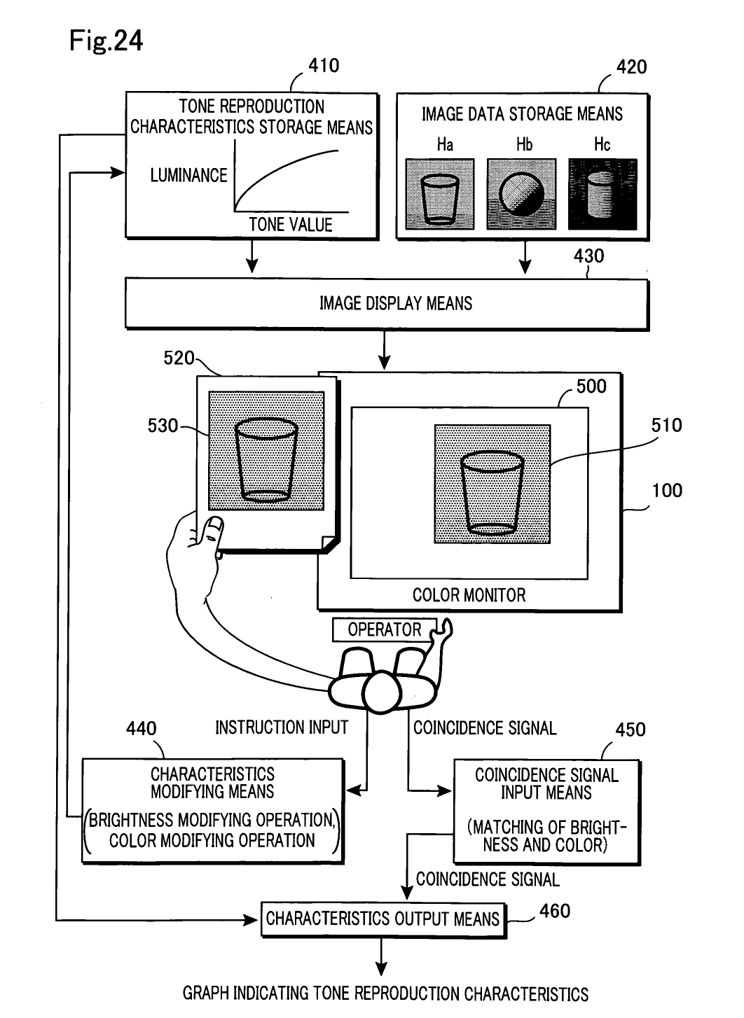

The arrangement and operations of a device for measuring tone reproduction characteristics of color monitors based on the principles described in Section 7 will now be described. FIG. 24 is a block diagram that shows the basic arrangement of this device. As illustrated, this device has a tone reproduction characteristics storage means 410, an image data storage means 420, an image display means 430, a characteristics modifying means 440, a coincidence signal input means 450, and a physical output media 520 as the major components, and has a function of measuring the tone reproduction characteristics of color monitor 100 based on visual measurement operations by the operator.

Of the respective components of this measuring device, the components besides physical output media 520 are all components that can be realized by installing a prescribed program in personal computer 200 connected to color monitor 100, and in actuality are realized by a program that is installed in personal computer 200.

Tone reproduction characteristics storage means 410 is a component for storing provisional tone reproduction characteristics, and specifically as shown in FIG. 20, is arranged by a storage device for storing data corresponding to the gamma curves Cr, Cg, and Cb, which respectively indicate the relationships between tone value and luminance for the three primary colors, R, G, and B, as shown in FIG. 20. The gamma curves that are stored here are provisional tone reproduction characteristics concerning color monitor 100, which is the object of measurement, and are modified gradually by the measurement tasks. In the final stage, the gamma curves stored here are output as the formal tone reproduction characteristics concerning color monitor 100.

Image data storage means 420 is a component that stores the image data of sample images to be used for measurement and is arranged by a storage device for data storage. With the embodiment described here, the image data of the three sample images Ha, Hb, and Hc, shown in FIG. 19, are prepared inside image data storage means 420. In general, the image data of a plurality (M) of sample images that differ in overall brightness are prepared inside image data storage means 420.

Image display means 430 is a component that performs a process of making the sample images prepared inside image data storage means 420 be displayed on screen 500 of color monitor 100. This image display means 430 has a function such that, when the tone reproduction characteristics of color monitor 100 are assumed to be the provisional tone reproduction characteristics stored inside tone reproduction characteristics storage means 410, prescribed tone corrections are made on the image data stored inside image data storage means 420 so that a sample image will be displayed on color monitor 100 with correct tone reproduction properties, and the image data after correction are provided to color monitor 100. A sample image 510 that is displayed on screen 500 is thus an image to which tone corrections, based on the provisional tone reproduction characteristics that are stored inside tone reproduction characteristics storage means 410 at that point, are applied.

Meanwhile, each physical output medium 520 is a component obtained by outputting a sample image onto a paper surface or other physical medium based on image data stored inside image data storage means 420 and has a sample image 530 printed on its surface. If M sample images are prepared inside image data storage means 420, M physical output media that respectively correspond to these M sample images are prepared. With the embodiment described here, since image data on the three sample images Ha, Hb, and Hc are prepared inside image data storage means 420, the three physical output media 520a, 520b, and 520c are prepared as shown in FIGS. 21 to 23.

The operator visually compares a sample image 510 on screen 500 with a sample image 530 on a physical output medium 520, and for this process, the sizes of the images are preferably set to be substantially the same. This is because when the brightness and color of two images are compared by the naked eyes, a more accurate comparison is enabled when the images are of substantially the same size. Thus in preparing a physical output medium 520 using a printer, it is preferable to make arrangements so that a sample image 530 of substantially the same size as sample image 510 on screen 500 will be printed.

Characteristics modifying means 440 has a function of receiving, from the operator who visually compares sample image 510, displayed on screen 500 of the color monitor, and sample image 530, displayed on physical output medium 520, instruction inputs in the direction of making the images become matched in brightness and color, and modifying the provisional tone reproduction characteristics stored in tone reproduction characteristics storage means 410 based on the instruction inputs.

With the embodiment described in Section 7, the modification operations by characteristics modifying means 440 are performed in a manner wherein the brightness modifying operation and the color modifying operation are performed separately. The brightness modifying operation is the operation of modifying the tone reproduction characteristics based on an instruction input that instructs mainly the changing of the brightness of sample image 510 displayed on screen 500 and, for example, is executed based on an instruction input that moves slide bar 511, shown in FIG. 21, to the left or right. Meanwhile, the color modifying operation is the operation of modifying the tone reproduction characteristics based on an instruction input that instructs mainly the changing of the color of sample image 510 displayed on screen 500 and, for example, is executed based on an instruction input that moves slide bar 512 or 513, shown in FIG. 21, to the left or right. As described in Section 7, when the brightness modifying operation is performed, all of the respective gamma curves of the three primary colors, R, G, and B that are stored in tone reproduction characteristics storage means 410 are modified, while when the color modification operation is performed, only the gamma curves of the colors subject to modification are modified.

Also as described above, the modification of a gamma curve is stressed on portions corresponding to the brightness of the sample image that is used for visual comparison, and for example, when visual comparison of sample image Ha of a bright picture is performed, modification is stressed mainly on the vicinity of the tone value of 197 shown in FIG. 20.

In general, when an instruction input concerning an i-th sample image among a plurality (M) of sample images is received, modifications stressed on “the portions corresponding to the brightness of the i-th sample image” are made on the provisional tone reproduction characteristics stored in tone reproduction characteristics storage mean 410. In the case of the specific example described in Section 7, when characteristics modifying means 440 receives an instruction input concerning the i-th sample image, the point on a gamma curve with the representative tone value of the i-th sample image is recognized as the control point and the modification of approaching the true tone reproduction characteristics is performed by moving the control point in a prescribed direction in accordance with the instruction input and thereafter modifying the gamma curve smoothly so that it passes through the control point after movement. Here, as the representative tone value of the sample image, the mode value or the average value of the pixel values of all colors of the individual pixels indicated by the image data stored in image data storage means 420 is used.

Coincidence signal input means 450 is the component that inputs, from the operator the coincidence signal, which indicates the recognition that sample image 510 and sample image 530 are matched in brightness and color. Match buttons 514, shown in FIGS. 21 to 23, are buttons for indicating the recognition of matching in regard to a specific sample image, and coincidence signal input means 450 can be realized by a component that judges that the coincidence signal has been input from the operator when, for example, match button 514 has been clicked for all sample images. Or, a special button that indicates that the matching has been recognized for all sample images may be prepared separately.

Characteristics output means 460 outputs a graph, indicating the provisional tone reproduction characteristics (the gamma curves Cr, Cg, and Cb) stored in tone reproduction characteristics storage means 410 at the point at which the coincidence signal has been input from the coincidence signal input means, as the formal tone reproduction characteristics of color monitor 100. The tone reproduction characteristics that have thus been output are the final measurement results of the tone reproduction characteristics measuring device according to the present invention.

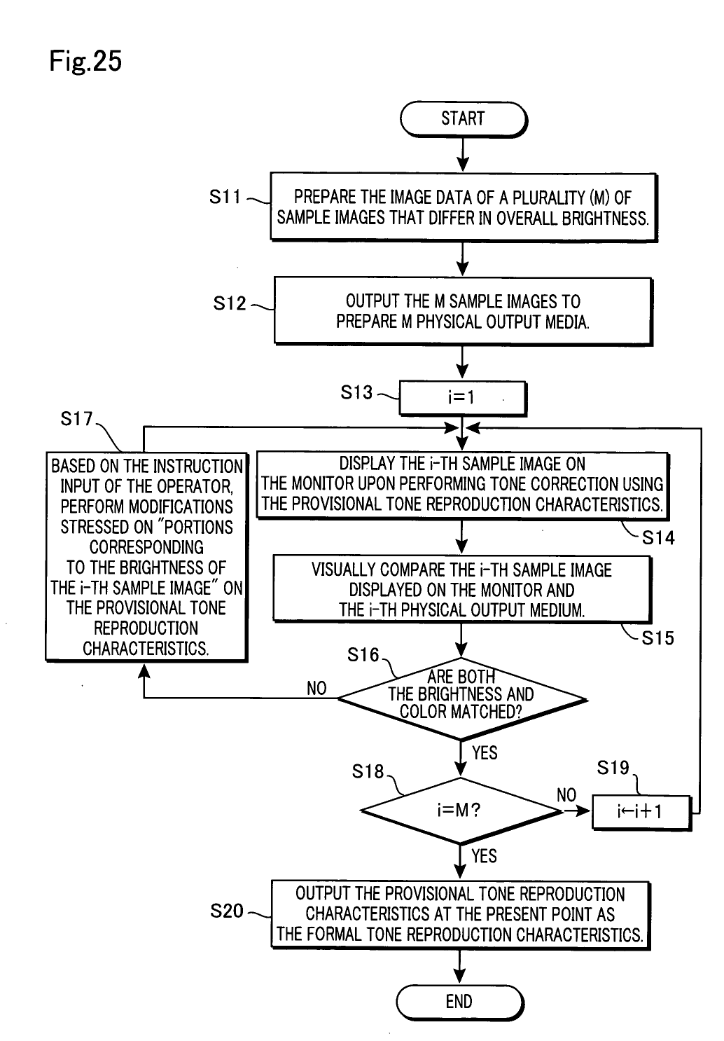

FIG. 25 is a flowchart showing the characteristic measurement process procedures using the measuring device shown in FIG. 24. First, in step S11, the image data of a plurality (M) of sample images that differ in overall brightness are prepared. With the above-described example, M=3 and the image data of three sample images Ha, Hb, and Hc are prepared. In step S12, which follows, a printer, etc., is used to output the M sample images onto physical media and M physical output media are thereby prepared. With the above-described example, the three physical media 520a, 520b, and 520c are prepared.

Next in step S13, the parameter i is set to the initial value of 1. This parameter i is a parameter for repeating the same procedure on each of the M sample images and is incremented by 1 each time in step S19 until i=M is reached in step S18.

In step S14, the process of displaying the i-th sample image on color monitor 100 upon performing the tone corrections using the provisional tone reproduction characteristics is performed. In the case of the above-described example, when the parameter i=1, the first sample image 510a is displayed on screen 500 as shown in FIG. 21. The next step S15 is a process operation performed by the operator, and the i-th sample image displayed on color monitor 100 and the i-th physical output medium are compared visually. When the parameter i=1, sample image 510a and sample image 530a are compared as shown in FIG. 21.

In step S16, whether or not it is recognized that both the brightness and color are matched as a result of comparison is judged, and if matching is not recognized, modifications are performed in step S17. That is, modifications stressed on the “portions corresponding to the brightness of the i-th sample image” are performed according to the instruction input of the operator on the provisional tone reproduction characteristics stored in tone reproduction characteristics storage means 410 at this point.

The respective procedures of steps S14, S15, S16, and S17 are thus repeatedly executed until matching is recognized in step S16 (until match button 514 is clicked). When matching is recognized in step S16, step S18 and step S19 are carried out to renew the parameter i and then the same processes are executed on the next sample image. When the same processes have thus been completed for all of the M sample images, step S20 is entered from step S18 and the process of outputting the provisional tone reproduction characteristics, which are stored in tone reproduction characteristics storage means 410 at this point, as the formal tone reproduction characteristics is executed.

<<<Section 9. Modification Examples Using Representative Luminance Values in Place of Representative Tone Values>>>

Lastly, modification examples of the embodiments described in Section 7 and Section 8 will be described. With the embodiment described in Section 7, a representative tone value is defined for each sample image, and in the modification operations using a specific sample image, modifications stressed on the portions of the vicinity of the representative tone value of the sample image are performed on the gamma curves that indicate the tone reproduction characteristics. For example, since the representative tone value of sample image Ha, shown in FIG. 19, is 197, modifications, using the points Q7, Q8, and Q9, which have the tone value of 197 on the respective gamma curves as shown in FIG. 20, as the control points, are carried out in the modification operations using sample image Ha.

With a modification example described here, a representative luminance value is defined for each sample image, and in modification operations using a single sample image, modifications stressed on the portions in the vicinity of the representative luminance value of the sample image are performed on the gamma curves that indicate the tone value reproduction characteristics.

Since the tone values of a sample image are provided as the pixel values of the individual pixels that make up the image data of the sample image, the representative tone value can be determined uniquely as the mode value or average value of these pixel values. On the other hand, the luminance value of a sample image are values that can be determined only after the sample image has been displayed on a monitor or output on a physical output medium. Thus even if the respective image data for three sample images Ha, Hb, and Hc are prepared in image data storage means 420, the representative luminance values of the respective sample images Ha, Hb, and Hc cannot be determined directly from the image data. The present inventor considers the following two methods to be effective as methods for determining the representative luminance values of the respective sample images Ha, Hb, and Hc.

In a first method, a value, obtained by conversion by a prescribed conversion method based on the representative tone value, is used as the representative luminance value. Generally as shown in FIG. 20, the relationship between tone value and luminance value is not a linear relationship and a unique curve is exhibited in accordance with the monitor or printer, etc. In the first place, this invention's tone reproduction characteristics measuring device is a device for determining such curves. However, the representative luminance value that is to be determined here does not need to be an accurate value. This is because the role of the representative tone value or the representative luminance value in this invention is to simply serve as an index for indicating which portions of the gamma curves indicating the tone reproduction characteristics should be stressed in carrying out modifications, and exactness is thus not required.

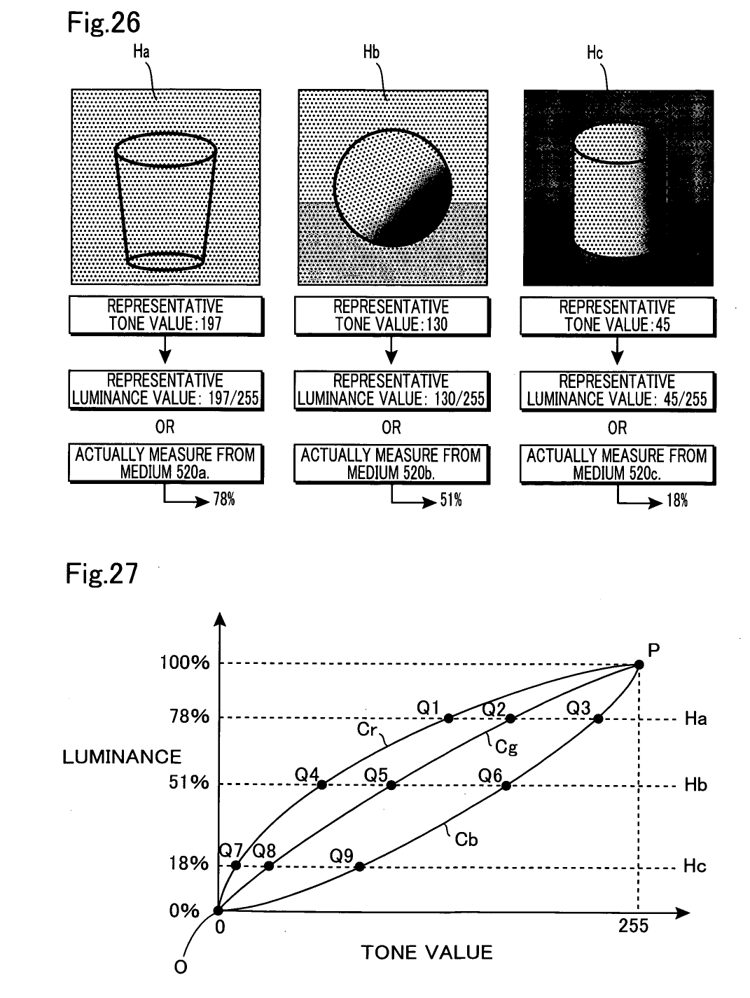

Thus by defining a rough relationship, such as “the tone value and the luminance value are in a linear relationship,” the representative luminance value can be converted uniquely from the representative tone value. FIG. 26 is a diagram showing an example of such conversion results. Here, under the premise that the tone values take on a range of 0 to 255, the luminance values take on a range of 0% to 100%, and these are in a linear relationship, the simple conversion equation of: luminance value=tone value/255 is defined. As a result, the representative luminance value of sample image Ha is determined based on the representative tone value 197 as being “197/255=78%,” the representative luminance value of sample image Hb is determined based on the representative tone value 130 as being “130/255=51%,” and the representative luminance value of sample image Hc is determined based on the representative tone value 45 as being “45/255=18%.” Though such representative luminance values determined by such conversion are obviously not accurate values, these are adequate for use as indices indicating positions of the gamma curves to be stressed in making modifications.

Needless to say, more accurate conversions can be carried out. For example, in general, data files, called ICC profiles, which have been established by the ICC (International Color Consortium), are used to carry out color management between a personal computer and input/output equipment. With many commercially available printers, ICC profiles are provided by manufacturers and ICC profiles can also be prepared for an arbitrary printer by known measurement methods. Arbitrary RGB tone values can be converted to a luminance value using such an ICC profile. Thus by using the ICC profile of the specific printer that was used to output the physical media, more accurate conversion from the representative tone value to the representative luminance value is enabled.

A second method is to use a physical measuring device to actually measure the average luminance of the entirety of the sample image on a physical output medium and use the actually measured value as it is as the representative luminance value of the sample image. Specifically, the representative luminance value for sample image Ha is determined by actual measurement of physical output medium 520a, shown in FIG. 21, the representative luminance value for sample image Hb is determined by actual measurement of physical output medium 520b, shown in FIG. 22, and the representative luminance value for sample image Hc is determined by actual measurement of physical output medium 520c, shown in FIG. 23. Though this method requires actual measurements by a physical method, accurate representative luminance values can be obtained.

When the representative luminance values have been obtained for the respective sample images, the control points are defined in accordance with the representative luminance values, and the gamma curves are modified accordingly. FIG. 27 is a graph for describing the concept of modifications stressed on portions in the vicinity of the representative luminance values. When, as in the example of FIG. 26, the representative luminance value of sample image Ha is determined as being 78%, the representative luminance value of sample image Hb is determined as being 51%, and the representative luminance value of sample image Hc is determined as being 18%, modifications on the respective curves using sample image Ha are performed by moving the control points Q1, Q2, and Q3, modifications on the respective curves using sample image Hb are performed by moving the control points Q4, Q5, and Q6, and modifications on the respective curves using sample image Hc are performed by moving the control points Q7, Q8, and Q9 as shown in FIG. 27.

<<<Section 10. Method of Automatically Varying the Tone Reproduction Characteristics>>>

With the embodiments described in Section 7 to Section 9, examples, wherein instructions from the operator are input by operation of slide bars 511 to 513, such as shown in FIGS. 21 to 23 and the tone value reproduction characteristics (gamma curves) are modified based on these instructions, were described. Here, a method of lightening the load of such instruction inputs by the operator will be described.

The central aim of this method is the same as that of the embodiment described in Section 3. That is, the shape of a gamma curve is varied automatically with time in accordance with prescribed variation conditions that had been determined in advance, and the operator is made to view a sample image on the screen of a color monitor and a sample image on a physical output medium and instruct the point at which the brightness and color can be recognized to be matched most closely. By repeating the same process under various variation conditions, the shape of the provisional gamma curve is made to approach the shape of the true gamma curve gradually. And at the stage at which approximation of some degree is achieved, the operator is made to input the coincidence signal that indicates the recognition that the images are matched in brightness and color, and the provisional gamma curves at that point are output as the formal gamma curves.

With the above-described embodiment, when, for example, a modification operation concerning the yellow/blue color is to be performed using sample image Ha, shown in FIG. 19, the operator is made to adjust slide bar 512, shown in FIG. 21 to perform a modification of moving the control point Q9 on the gamma curve Cb, shown in FIG. 20, in a prescribed direction. With the embodiment described here, the shape of the gamma curve Cb is varied with time by automatically and cyclically varying the position of the control point Q9 in a prescribed direction.

For example, the control point Q9 shown in FIG. 20 is a point having a tone value of 197, and when this tone value is varied within a range of±5, the tone value of the control point Q9 is varied within the range of 192 to 202. Consequently, the position of the control point Q9 undergoes reciprocating motion to the left and right in FIG. 20. Obviously, when the position of the control point Q9 changes, the shape of the gamma curve Cb is also varied smoothly so that it passes through the position of the new control point Q9. The gamma curve Cb is thus modified repeatedly in a cyclic manner within a prescribed range based on the shape shown in FIG. 20. By thus varying the gamma curve Cb cyclically, the yellow/blue color of sample image 510a, shown in FIG. 21, is varied cyclically and the same effect as the operations of moving slide bar 512 to the left and right in the above-described embodiment is provided.

To summarize, the embodiment described here provides the same effect as moving the slide bar, shown in FIG. 21, to the left and right automatically at the system side. Needless to say, slide bars 511 to 513, such as shown in FIG. 21, do not need to be provided. The operator views sample images 510a and 530a and, at the point at which he/she recognizes that the yellow/blue color of the images have become closest to each other, performs the instruction input indicating this by a mouse click or other method. Since the gamma curve Cb at the point at which the operator performs the instruction input will be the most preferable gamma curve at that point, modification using this curve as the new gamma curve Cb is performed.

The gamma curves Cg and Cr are also modified by the same method. That is, here, the gamma curve Cg is varied cyclically by moving the control point Q8 in a reciprocating manner to the left and right, the operator is made to perform instruction input at the point at which he/she recognizes that the red/green color of the images have become closest to each other, and the gamma curve at that point is handled as the new gamma curve Cg. Likewise, the gamma curve Cr is varied cyclically by moving the control point Q7 in a reciprocating manner to the left and right, the operator is made to perform instruction input at the point at which he/she recognizes that the red/green color of the images have become closest to each other, and the gamma curve at that point is handled as the new gamma curve Cr.

Meanwhile for the recognition of brightness matching, the control points Q7 to Q9 are moved reciprocatingly to the left and right at the same phase to thereby vary the three gamma curves Cr, Cg, and Cb simultaneously, the operator is made to perform instruction input at the point at which the images have become closest to each other in brightness, and the respective gamma curves at that point are handled as the new gamma curves Cr, Cg, and Cb.

Obviously when such a brightness modification process is executed, the color balance that had been adjusted may become disrupted, and oppositely when a color modification process is executed, the brightness balance may become disrupted. Thus for practical use, the adjustment of color and the adjustment of brightness are executed in alternation repeatedly and arrangements are made to gradually narrow the range of variation of the control point as in the embodiment described in Section 3. The direction of variation of the control point may be a vertical direction or an inclined direction.

When the modifications using sample image Ha shown in FIG. 19 are completed, the modification processes using sample image Hb are performed. Here, the control points Q4, Q5, and Q6, shown in FIG. 20, are respectively varied within prescribed ranges and modifications of mainly varying the central portions of the respective gamma curves Cr, Cg, and Cb are performed. Lastly, the modification processes using sample image Hc are performed. Here, the control points Q1, Q2, and Q3, shown in FIG. 20, are respectively varied within prescribed ranges and modifications of mainly varying the dark portions of the respective gamma curves Cr, Cg, and Cb are performed. Obviously, a second round of the modification processes using sample image Ha may thereafter be executed.

When after performing such modification processes, the recognition, that the sample images are matched (or have become close to each other within a certain allowable range) in both brightness and color, is obtained as a result of visual comparison by the operator, the final coincidence signal is made to be input. However, for practical use, a signal that takes the form of a “final coincidence signal” does not need to be input anew necessarily, and it suffices to handle the instruction input (instruction indicating that the color or brightness have become matched most closely), which is input lastly in the adjustment operations concerning sample image Hc, as the final coincidence signal.

Though an embodiment of automatically varying the tone reproduction characteristics has been described, in consideration of the computational capability of present computers, some measures are needed for practical use in order to put the embodiment described in this Section 10 into practice. With both the embodiment described in Section 3 and the embodiment described in this Section 10, the color and brightness of the displayed object on the screen appear to vary gradually with time to the operator. However, in terms of the contents of processing by the system, whereas in the case of the embodiment described in Section 3, tone value varying means 240 (FIG. 18) needs to vary only the tone value inside tone value designating means 210 directly and thus just a process of simply increasing or decreasing the digital data needs to be performed, in the case of the embodiment described in this Section 10, characteristics modifying means 440 (FIG. 24) must perform the process of modifying a gamma curve stored in tone reproduction characteristics storage means 410. Moreover, since the curve after modification must be a curve that passes through the control point at a specific position, the computational load for determining such a curve is considerably large.

Though in both the embodiment described in Section 3 and the embodiment described in this Section 10, a cyclically varying image must be displayed to the operator, a display cycle that is too long will be poor in terms of practical use. For example, a form of operation, wherein, while displaying an image that varies in a cycle of 10 seconds, the point at which compared images become closest to each other is to be instructed by an operator, is sufficiently practical. However, if the cycle of variation becomes of the order of 10 minutes, it becomes difficult for the operator to maintain his/her attention and this is thus poor in terms of practical use. Thus in consideration of a case of using a personal computer of comparatively low processing speed, a real time process, wherein, while moving the control point Q9, shown in FIG. 20, reciprocatingly to the left and right, a new gamma curve Cb is determined by computation each time and displaying a new image using this new gamma curve Cb, is poor in terms of practical use.

Thus in carrying out the method described in this Section 10, a plurality of gamma curves within the range of variation are preferably computed in advance prior to display of an image to the operator. For example, in the case of performing the adjustments (that is adjustments using sample image Ha) of cyclically moving the control points Q7, Q8, and Q9, shown in FIG. 20, all of the necessary gamma curves are determined in advance by computation. Specifically, in the case of varying the tone value of the control point Q9 by just±5 for the gamma curve Cb, a total of ten curves, that is, the curve for the case where the control point is moved by 5 tone value increments to the left, the curve for the case where the control point is moved by 4 tone value increments to the left, . . . the curve for the case where the control point is moved by 4 tone value increments to the right, and the curve for the case where the control point is moved by 5 tone value increments to the right are computed in advance. The same is applied to the gamma curves Cr and Cb. While the operator performs the adjustment operations concerning sample image Ha, the priorly computed plurality of gamma curves are used to perform image display.

Subsequently, based on the three gamma curves Cr, Cg, and Cb obtained as a result of the adjustment operations concerning sample images Ha, a plurality of gamma curves that are obtained by moving the respective control points Q4, Q5, and Q6 within the prescribed range are determined before the operator performs the adjustment operations concerning the next sample image Hb. Likewise, based on the three gamma curves Cr, Cg, and Cb obtained as a result of the adjustment operations concerning sample images Hb, a plurality of gamma curves that are obtained by moving the respective control points Q1, Q2, and Q3 within the prescribed range are determined before the operator performs the adjustment operations concerning the last sample image Hc.

By employing such a method of determining the necessary gamma curves in advance prior to the image display, smooth image display can performed in comparison to the case where image display is performed while performing computations in real time.

### INDUSTRIAL APPLICABILITY

The reproduction characteristics measuring device for color monitor according to the present invention can be used in applications of visually measuring the tone reproduction characteristics of a color monitor having the function of displaying color images using the three primary colors of R, G, and B. In particular, this invention is suitable for applications of determining highly precise tone reproduction characteristics and performing corrections of higher precision in a color monitor that is used for DTP processes of preparing printed matter and also enables measurements of adequate precision for liquid crystal color displays as well as CRT color monitors that have undergone aged deterioration.

1. A device for measuring tone reproduction characteristics, which indicate a relationship between input signal tone values and actual display luminance of a color monitor (100) having a function of displaying color images using three primary colors of R, G, and B, the tone reproduction characteristics measuring device for color monitor comprising:
tone value designating means (210), designating a combination of tone values of the three primary colors, R, G, and B, for displaying an even pattern of uniform brightness and color in a first attribute region (50);
reference pattern generating means (220) generating a reference pattern in which first sub-regions (61) and second sub-regions (62) are mixed at a prescribed area ratio inside a second attribute region (60), wherein each of the three primary colors, R, G, and B take on a minimum tone value in said first sub-regions and each of the three primary colors, R, G, and B take on a maximum tone value in said second sub-regions;
pattern display means (230) defining a test pattern which is arranged from said first attribute region and said second attribute region being positioned so as to contact each other on a screen of the color monitor, and providing prescribed signals to the color monitor so that an even pattern, based on the combination of tone values designated by said tone value designating means, is displayed in said first attribute region, and said reference pattern, generated by said reference pattern generating means, is displayed in said second attribute region;
tone value varying means (240) varying respective tone values designated by said tone value designating means so as to vary a brightness and a color of the even pattern;
coincidence signal input means (250) inputting, while a varying operation by said tone value varying means is being performed, a coincidence signal indicating a recognition that said first attribute region and said second attribute region are matched in both brightness and color, from an operator who views said test pattern displayed on the screen of the color monitor; and
characteristics computing means (260) recognizing a combination of tone values designated by said tone value designating means at a point when said coincidence signal is input, as corresponding tone values of the respective primary colors that correspond to a prescribed reference luminance in accordance with said prescribed area ratio, and determining, by computation, tone reproduction characteristics of the respective primary colors based on said reference luminance and said corresponding tone values that correspond to each other.

2. The tone reproduction characteristics measuring device for color monitor according to claim 1, wherein:
the tone value varying means (240) has a function of performing two types of varying operations of a brightness varying operation, with which the tone values are varied so that mainly a brightness of the even pattern changes, and a color varying operation, with which a tone value is varied so that mainly a color of the even pattern changes.

3. The tone reproduction characteristics measuring device for color monitor according to claim 2, wherein:
the brightness varying operation is performed by a task of increasing or decreasing all of respective tone values of the three primary colors, R, G, and B by a common variation amount, and
the color varying operation is performed by a task of increasing or decreasing a tone value of a single specific color among the three primary colors, R, G, and B.

4. The tone reproduction characteristics measuring device for color monitor according to claim 1, wherein:
the tone value varying means (240) performs variations of the tone values based on operation inputs by the operator.

5. The tone reproduction characteristics measuring device for color monitor according to claim 4, wherein:
the tone value varying means (240) uses a first button (31) that provides an instruction of making the even pattern brighter, a second button (32) that provides an instruction of making the even pattern darker, a third button (33) that provides an instruction of strengthening a component of a specific color of the even pattern, and a fourth button (34) that provides an instruction of weakening a component of the specific color of the even pattern, and performs a varying operation of adding a common variation amount to all of the respective tone values of the three primary colors, R, G, and B, when there is an operation input in regard to the first button, performs a varying operation of subtracting a common variation amount from all of the respective tone values of the three primary colors, R, G, and B, when there is an operation input in regard to the second button, performs a varying operation of adding a prescribed variation amount to a tone value of the specific color when there is an operation input in regard to the third button, and performs a varying operation of subtracting a prescribed variation amount from a tone value of the specific color when there is an operation input in regard to the fourth button.

6. The tone reproduction characteristics measuring device for color monitor according to claim 5, wherein:
a two-dimensional XY coordinate system is defined and the respective buttons are positioned so that the first button (31) and the second button (32) are positioned at opposing positions along an X-axis that sandwich an origin and the third button (33) and the fourth button (34) are positioned at opposing position along a Y-axis that sandwich the origin.

7. The tone reproduction characteristics measuring device for color monitor according to claim 1, wherein:
the tone value varying means (240) varies the tone values with time in accordance with prescribed rules that have been established in advance.

8. The tone reproduction characteristics measuring device for color monitor according to claim 7, wherein:
the tone value varying means (240) has a function of performing two varying operations of a brightness varying operation, wherein, by adding or subtracting a common variation amount at a prescribed timing to or from all of respective tone values of the three primary colors, R, G, and B, the tone values are varied so that mainly the brightness of the even pattern changes, and a color varying operation, wherein, by adding or subtracting a prescribed variation amount at a prescribed timing to or from a tone value of one specific color among the three primary colors, R, G, and B, the tone value is varied so that mainly the color of the even pattern changes, and
the coincidence signal input means (250) has a brightness coincidence signal input means, for inputting, while the tone value varying means is performing the brightness varying operation, a brightness coincidence signal that indicates a recognition that the brightness is matched from the operator, and a color coincidence signal input means, for inputting, while the tone value varying means is performing the color varying operation, a color coincidence signal that indicates a recognition that the color is matched from the operator, and deems that a coincidence signal indicating a recognition of matching of both brightness and color is input when both inputs of the brightness coincidence signal and the color coincidence signal are completed.

9. The tone reproduction characteristics measuring device for color monitor according to claim 8, wherein:
when a tone value obtained by a varying operation of adding a variation amount exceeds a maximum tone value, a circulation process of incrementing a minimum tone value by an excess amount is performed, and when a tone value obtained by a varying operation of subtracting a variation amount falls below the minimum tone value, a circulation process of decrementing a maximum tone value by an excess amount is performed.

10. The tone reproduction characteristics measuring device for color monitor according to claim 8, wherein:
the tone value varying means (240) has a function of starting the color varying operation at a point when the brightness coincidence signal is input while the brightness varying operation is performed, starting the brightness varying operation at a point when the color coincidence signal is input while the color varying operation is performed, and repeatedly executing the brightness varying operation and the color varying operation in alternation and has a function of performing a repeated execution while gradually decreasing the tone value variation amount, and
the coincidence signal input means (250) deems that the coincidence signal indicating a recognition of matching of both brightness and color is input when both inputs of the brightness coincidence signal and the color coincidence signal are completed after the variation amount has reached a predefined value.

11. The tone reproduction characteristics measuring device for color monitor according to claim 3, wherein:
of the three primary colors, R, G, and B, the primary color B is deemed to be the specific color and tone reproduction characteristics for the primary color B and tone reproduction characteristics in common to the primary colors R and G are determined.

12. The tone reproduction characteristics measuring device for color monitor according to claim 1, wherein:
the reference pattern generating means (220) has a function of setting a plurality N of area ratios of the first sub-regions to the second sub-regions and generating N reference patterns that differ mutually in reference luminance, and
the characteristics computing means (260) has a function of determining the tone reproduction characteristics for the respective primary colors based on N corresponding tone values obtained for N test patterns using the N reference patterns.

13. The tone reproduction characteristics measuring device for color monitor according to claim 12, wherein:
the characteristics computing means (260) defines a two-dimensional coordinate system in which a first coordinate axis is set for tone value and a second coordinate axis is set for luminance, plots N points having respective luminance values and corresponding tone values as coordinate values on the coordinate system, plots a point having a minimum luminance value and a minimum tone value as coordinate values, and a point having a maximum luminance value and a maximum tone value as coordinate values, and determines a curve passing through the total of (N+2) plotted points in a form of a graph that indicates the tone reproduction characteristics.

14. The tone reproduction characteristics measuring device for color monitor according to claim 13, wherein:
N is set equal to 3, a total of five points are plotted, and upon referring to these five points as a first point to a fifth point in the order of increasing coordinate value along the first coordinate axis, a first function curve, passing through the first, second, and third points and taking a form of expressing the luminance as a power of the tone value, and a second function curve, passing through the third, fourth, and fifth points and taking a form of expressing the luminance as a power of the tone value are determined by computation, and a curve formed by joining the first function curve and the second function curve is deemed to be the curve expressing the tone reproduction characteristics.

15. The tone reproduction characteristics measuring device for color monitor according claim 1, wherein:
the reference pattern generating means (220) forms the first sub-regions and the second sub-regions from unit cells having the same shape and size and forms the reference pattern from a two-dimensional array of these unit cells.

16. The tone reproduction characteristics measuring device for color monitor according to claim 15, wherein:
the reference pattern is formed by arraying rectangular unit cells in a two-dimensional array, and for arbitrary odd numbers i and j, a cell group, formed of four unit cells of a unit cell of an i-th row and a j-th column, a unit cell of the i-th row and a (j+1)-th column, a unit cell of an (i+1)-th row and the j-th column, and a unit cell of the (i+1)-th row and the (j+1)-th column, is defined, and a common positioning pattern of the first sub-regions and the second sub-regions is applied for all cell groups.

17. The tone reproduction characteristics measuring device for color monitor according to claim 16, wherein:
among the four unit cells which make up a cell group, first sub-regions are formed by a pair of unit cells adjacent diagonally and second sub-regions are formed by a remaining pair of unit cells so as to constitute a reference pattern with an area ratio of 1:1.

18. The tone reproduction characteristics measuring device for color monitor according to claim 16, wherein:
among the four unit cells which make up a cell group, one unit cell constitutes one sub-region and remaining three unit cells constitute the other sub-region so as to constitute a reference pattern with an area ratio of 3:1 or 1:3.

19. The tone reproduction characteristics measuring device for color monitor according to claim 1, wherein:
a contour of the first attribute region or the second attribute region that makes up the test pattern is made of a circle or an ellipse.

20. The tone reproduction characteristics measuring device for color monitor according to claim 1, wherein:
one attribute region that makes up the test pattern is made of a plurality of regions positioned in a dispersed manner and the other attribute region is made of a background portion thereof.

21. The tone reproduction characteristics measuring device for color monitor according to claim 20, wherein:
a total area of the first attribute region is made equal to a total area of the second attribute region.

22. The tone reproduction characteristics measuring device for color monitor according to claim 20, wherein:
a plurality of regions of the same attribute that are the same in shape and size are positioned dispersedly in a two-dimensional plane at a prescribed pitch so that a prescribed spatial frequency is obtained.

23. The tone reproduction characteristics measuring device for color monitor according to claim 22, wherein:
a plurality of one-dimensional region arrays, in each of which a plurality of regions of the same attribute are positioned in a horizontal direction at a prescribed pitch Px, are positioned in a vertical direction at a prescribed pitch Py (where Py=(√3)/2·Px) and positioned so that among mutually adjacent one-dimensional region arrays, the phase is shifted by half a pitch.

24. The tone reproduction characteristics measuring device for color monitor according to claim 22, wherein:
regions of the same attribute are positioned dispersedly at a prescribed pitch by which a spatial frequency that exhibits good sensitivity in regard to both brightness difference discrimination characteristics and color difference discrimination characteristics for the operator viewing the test pattern is obtained.

25. The tone reproduction characteristics measuring device for color monitor according to claim 22, wherein:
a first pitch, by which a spatial frequency that exhibits good sensitivity in regard to brightness difference discrimination characteristics for the operator viewing the test pattern is obtained, and a second pitch, by which a spatial frequency that exhibits good sensitivity in regard to color difference discrimination characteristics for the operator viewing the test pattern is obtained, are set, and
the pattern display means (230) has a function of displaying a test pattern, formed by dispersedly positioning regions of the same attribute at the first pitch, when a brightness matching recognition task is performed by the operator, and displaying a test pattern, formed by dispersedly positioning regions of the same attribute at the second pitch, when a color matching recognition task is performed by the operator.

26. (canceled)

27. A device for measuring tone reproduction characteristics, which indicate a relationship between input signal tone values and actual display luminance of a color monitor (100) having a function of displaying color images using three primary colors of R, G, and B, the tone reproduction characteristics measuring device for color monitor comprising:
tone reproduction characteristics storage means (410) storing provisional tone reproduction characteristics;
image data storage means (420) storing image data of a sample image to be used in measurement;
image display means (430) which assumes that the tone reproduction characteristics of the color monitor are to be the provisional tone reproduction characteristics stored in the tone reproduction characteristics storage means, performs prescribed tone corrections on image data stored in the image data storage means so that the sample image will be displayed with correct tone reproduction on the color monitor, and provides corrected image data to the color monitor;
a physical output medium (520) obtained by outputting the sample image on a physical medium based on the image data stored in the image data storage means;
characteristics modifying means (440) receiving instruction inputs, for making a sample image (510) displayed on a screen (500) of the color monitor, and a sample image (530) displayed on the physical output medium (520), close in brightness and color, from an operator who visually compares the two images;
coincidence signal input means (450) inputting a coincidence signal, indicating a recognition that both of the images are matched both in brightness and color, from the operator; and
characteristics output means (460) outputting the provisional tone reproduction characteristics, stored in the tone reproduction characteristics storage means when the coincidence signal is input, as a formal tone reproduction characteristics of the color monitor.

28. The tone reproduction characteristics measuring device for color monitor according to claim 27, wherein:
image data of a plurality M of sample images that differ in overall brightness are stored in the image data storage means (420) and M physical output media (520), respectively corresponding to the M sample images, are prepared; and
the characteristics modifying means (440), upon receiving an instruction input concerning an i-th sample image among the M sample images, performs modifications stressed on “a portion corresponding to a brightness of the i-th sample image” on the provisional tone reproduction characteristics stored in the tone reproduction characteristics storage means.

29. The tone reproduction characteristics measuring device for color monitor according to claim 28, wherein:
the tone reproduction characteristics storage means (410) stores curves, respectively indicating relationships between tone value and luminance for the three primary colors, R, G, and B, in a form of graphs indicating the tone reproduction characteristics, and
the characteristics modifying means (440), upon receiving an instruction input concerning an i-th sample image, recognizes a point on a curve, having a representative tone value of the i-th sample image, as a control point, and after moving the control point in a prescribed direction in accordance with the instruction input, modifies the curve smoothly so that it passes through the control point after movement.

30. The tone reproduction characteristics measuring device for color monitor according to claim 29, wherein:
a mode value or an average value of pixel values of all colors of individual pixels indicated by the image data stored in the image data storage means is used as a representative tone value of the sample image.

31. The tone reproduction characteristics measuring device for color monitor according to claim 28, wherein:
the tone reproduction characteristics storage means (410) stores curves, respectively indicating relationships between tone value and luminance for the three primary colors, R, G, and B, in a form of graphs indicating the tone reproduction characteristics, and
the characteristics modifying means (440), upon receiving an instruction input concerning an i-th sample image, recognizes a point on a curve, having a representative luminance value of the i-th sample image, as a control point, and after moving the control point in a prescribed direction in accordance with the instruction input, modifies the curve smoothly so that it passes through the control point after movement.

32. The tone reproduction characteristics measuring device for color monitor according to claim 31, wherein:
a mode value or an average value of pixel values of all colors of individual pixels indicated by the image data stored in the image data storage means is determined as the representative tone value of the sample image, and a value converted by a prescribed conversion method based on the determined representative tone value is used as the representative luminance value of the sample image.

33. The tone reproduction characteristics measuring device for color monitor according to claim 31, wherein:
an actually measured value of luminance of an entire sample image on the physical output medium is used as the representative luminance value of the sample image.

34. The tone reproduction characteristics measuring device for color monitor according to claim 27, wherein:
the characteristics modifying means (440) performs processes of varying the tone reproduction characteristics with time in accordance with prescribed rules that have been established in advance and performs modifications wherein provisional tone reproduction characteristics when an instruction input from the operator is provided are deemed to be new provisional tone reproduction characteristics.

35. The tone reproduction characteristics measuring device for color monitor according to claim 34, wherein:
image data of a plurality M of sample images that differ in overall brightness are stored in the image data storage means (420) and M physical output media (520), respectively corresponding to the M sample images are prepared, and
the characteristics modifying means (440) has a function of executing processes of performing variations stressed on “a portion corresponding to a brightness of an i-th sample image among the M sample images” on the provisional tone reproduction characteristics stored in the tone reproduction characteristics storage means (410) for each of i=1 to M.

36. The tone reproduction characteristics measuring device for color monitor according to claim 35, wherein:
the tone reproduction characteristics storage means (410) stores curves, respectively indicating relationships between tone value and luminance for the three primary colors, R, G, and B, in a form of graphs indicating the tone reproduction characteristics, and
the characteristics modifying means (440), in executing a process of performing variations stressed on “a portion corresponding to a brightness of an i-th sample image,” recognizes a point on each of the curves, having a representative tone value of the i-th sample image, as a control point, moves the control point in prescribed directions cyclically, and modifies the curve smoothly so that it passes through the control point after movement.

37. The tone reproduction characteristics measuring device for color monitor according to claim 36, wherein:
a mode value or an average value of pixel values of all colors of individual pixels indicated by the image data stored in the image data storage means is used as the representative tone value of the sample image.

38. The tone reproduction characteristics measuring device for color monitor according to claim 35, wherein:
the tone reproduction characteristics storage means (410) stores curves, respectively indicating relationships between tone value and luminance for the three primary colors, R, G, and B, in a form of graphs indicating the tone reproduction characteristics, and
the characteristics modifying means (440), in executing a process of performing variations stressed on “a portion corresponding to a brightness of an i-th sample image,” recognizes a point on each of the curves, having a representative luminance value of the i-th sample image, as a control point, moves the control point in prescribed directions cyclically, and modifies the curve smoothly so that it passes through the control point after movement.

39. The tone reproduction characteristics measuring device for color monitor according to claim 38, wherein:
a mode value or an average value of pixel values of all colors of individual pixels indicated by the image data stored in the image data storage means is determined as the representative tone value of the sample image, and a value converted by a prescribed conversion method based on the determined representative tone value is used as the representative luminance value of the sample image.

40. The tone reproduction characteristics measuring device for color monitor according to claim 38, wherein:
an actually measured value of luminance of an entire sample image on the physical output medium is used as the representative luminance value of the sample image.

41. The tone reproduction characteristics measuring device for color monitor according to claim 27, wherein:
the characteristics modifying means (440) has a function of performing two types of modifying operations of a brightness modifying operation of modifying the tone reproduction characteristics based on an instruction input for mainly changing the brightness of the sample image displayed on a screen of the color monitor, and a color modifying operation of modifying the tone reproduction characteristics based on an instruction input for mainly changing the color.

42. The tone reproduction characteristics measuring device for color monitor according to claim 41, wherein:
the tone reproduction characteristics storage means (410) stores curves, respectively indicating relationships between tone value and luminance for the three primary colors, R, G, and B, in a form of graphs indicating the tone reproduction characteristics, and
the characteristics modifying means (440), performs modification on all of the respective curves of the three primary colors R, G, and B in performing the brightness modifying operation, and performs modification on only a curve of a color to be modified in performing the color modifying operation.

43. The tone reproduction characteristics measuring device for color monitor according to claim 27, wherein:
an image, which can be recognized as a substantially achromatic image when viewed by the operator, is used as the sample image.

44. (canceled)

45. A device for measuring tone reproduction characteristics, which indicate a relationship between input signal tone values and actual display luminance of a color monitor having a function of displaying color images using three primary colors of R, G, and B, the tone reproduction characteristics measuring device for color monitor comprising:
means for determining a correspondence between luminance and tone value by visual recognition;
means for determining a combination of tone values of the three primary colors that appears to be achromatic; and
characteristics computing means determining, by computation, the tone reproduction characteristics for the respective primary colors from the correspondence between luminance and tone value and a combination of the three primary colors.

46. The tone reproduction characteristics measuring device for color monitor according to claim 5 wherein:
of the three primary colors, R, G, and B, the primary color B is deemed to be the specific color and tone reproduction characteristics for the primary color B and tone reproduction characteristics in common to the primary colors R and G are determined.

47. The tone reproduction characteristics measuring device for color monitor according to claim 8 wherein:
of the three primary colors, R, G, and B, the primary color B is deemed to be the specific color and tone reproduction characteristics for the primary color B and tone reproduction characteristics in common to the primary colors R and G are determined.
